(19) United States
(12) Patent Application Publication
(10) Pub. No.: US 2023/0420693 A1
(43) Pub. Date: Dec. 28, 2023

(54) SINGLE-ATOM CATALYST STRUCTURE AND PREPARATION METHOD THEREOF

(71) Applicant: INDUSTRY-UNIVERSITY COOPERATION FOUNDATION HANYANG UNIVERSITY ERICA CAMPUS, Ansan-si (KR)

(72) Inventors: Won Cheol Yoo, Yongin-si (KR); Hee Soo Kim, Seoul (KR); In Cheol Heo, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 18/449,749

(22) Filed: Aug. 15, 2023

Related U.S. Application Data
(63) Continuation of application No. PCT/KR2022/000428, filed on Jan. 11, 2022.

(30) Foreign Application Priority Data
Mar. 16, 2021 (KR) 10-2021-0033708
Jun. 18, 2021 (KR) 10-2021-0079194

(51) Int. Cl. H01M 4/90

(52) U.S. Cl. CPC H01M 4/9083; H01M 2004/8689

(57) ABSTRACT

A single-atom catalyst structure comprises: a three-dimensional ordered mesoporous carbon structure; and a single-atom catalyst doped inside the three-dimensional ordered mesoporous carbon structure, wherein the single-atom catalyst may comprise transition metal, nitrogen, and carbon. In an alternative implementation, a single-atom catalyst structure comprises: a three-dimensional ordered mesoporous carbon structure; and a single-atom catalyst doped inside the three-dimensional ordered mesoporous carbon structure, wherein the single-atom catalyst includes transition metal, nitrogen, and carbon.

### CROSS REFERENCE TO RELATED APPLICATIONS

This is a continuation of PCT/KR2022/000428 (filed 11 Jan. 2022), which claims the benefit of Republic of Korea Patent Application KR 10-2021-0079194 (filed 18 Jun. 2021) and Republic of Korea Patent Application KR 10-2021-0033708 (filed 16 Mar. 2021). The entire disclosure of each of these priority applications is hereby incorporated by reference herein.

### BACKGROUND OF THE INVENTION

### 1. Field of the Invention

The present invention relates to a single-atom catalyst structure and a preparation method thereof, and more specifically, to a single-atom catalyst structure and a preparation method thereof including transition metal, nitrogen, and carbon.

### 2. Description of the Prior Art

Due to an increase in the use of fossil fuels, problems such as air pollution, global warming or the like have occurred.

In order to solve the problems, interest in new eco-friendly energy sources is increasing.

Meanwhile, attention has been paid to a fuel cell which directly converts chemical energy generated by a chemical reaction between hydrogen and oxygen into electrical energy.

The fuel cell is based on a principle of direct power generation through an electrochemical reaction between hydrogen in fuel and oxygen in the air, in which hydrogen supplied to an anode is separated into hydrogen ions and electrons, and then the hydrogen ions move to a cathode and the electrons move to the cathode along an external circuit, and at this time, the electrons moving along the external circuit generate power. The final products are three types of water, electricity, and heat, which are in the spotlight as a next-generation energy source due to their high efficiency and no noise.

Platinum is used as most cathode catalysts used in fuel cells. However, platinum has a limited amount of metal due to small reserves, and thus there is a limit to continuous use, and an increase in cost is inevitable.

Thus, it is essential to develop an alternative catalyst having long-term operational stability and high catalytic activity, which can replace the catalyst, or to reduce its amount used.

### SUMMARY OF THE INVENTION

One technical object of the present invention is to provide a single-atom catalyst structure and a preparation method thereof.

Another technical object of the present invention is to provide a single-atom catalyst structure with an enhanced oxygen reduction reaction activity and a preparation method thereof.

Still another technical object of the present invention is to provide a single-atom catalyst structure with a reduced preparation cost and a preparation method thereof.

The technical objects of the present invention are not limited to the above.

To solve the above technical objects, the present invention may provide a method for preparing a single-atom catalyst structure.

According to one embodiment, the method for preparing a single-atom catalyst structure may include preparing a three-dimensional ordered mesoporous carbon structure, activating the three-dimensional ordered mesoporous carbon structure, and preparing a single-atom catalyst structure by doping a single-atom catalyst, including transition metal, nitrogen, and carbon, in the activated three-dimensional carbon structure.

According to one embodiment, the preparing of the three-dimensional ordered mesoporous carbon structure may include preparing a carbon source, providing the carbon source to a porous silicon oxide (FCC packed SiO₂ arrays) structure to prepare a silicon oxide-carbon pre-structure, heat-treating the silicon oxide-carbon pre-structure under an inert gas atmosphere to prepare a silicon oxide-carbon structure, and providing the silicon oxide-carbon composite in a first etching solution to prepare the three-dimensional ordered mesoporous carbon structure from which silicon oxide is removed.

According to one embodiment, the preparing of the three-dimensional ordered mesoporous carbon structure may include controlling a temperature of the first etching solution to control presence and absence of silicon in the three-dimensional ordered mesoporous carbon structure and presence and absence of silicon included in the single-atom catalyst structure.

According to one embodiment, in the preparing of the three-dimensional ordered mesoporous carbon structure, apart of the silicon not removed by the first etching solution remains in the three-dimensional ordered mesoporous carbon structure, so that silicon may be further included in the single-atom catalyst.

According to one embodiment, the preparing of the single-atom catalyst structure may further include providing a transition metal source and a nitrogen source to the activated three-dimensional ordered mesoporous carbon structure to prepare a transition metal-nitrogen-three-dimensional ordered mesoporous carbon structure mixture, heat-treating the transition metal-nitrogen-three-dimensional ordered mesoporous carbon structure mixture to prepare a composite mixture including transition metal particles, transition metal oxide particles, and the single-atom catalyst structure, and providing the composite mixture into a second etching solution to remove the transition metal particles and the transition metal oxide particles, and leaving the single-atom catalyst.

According to one embodiment, the second etching solution may include acid solution.

To solve the above technical objects, the present invention may provide a single-atom catalyst structure.

According to one embodiment, the single-atom catalyst structure may include a three-dimensional ordered mesoporous carbon structure and a single-atom catalyst doped inside the three-dimensional ordered mesoporous carbon structure, in which the single-atom catalyst may include transition metal, nitrogen, and carbon.

According to one embodiment, the single-atom catalyst may be configured in which each of the three or more nitrogen elements is bonded to the transition metal element, and the nitrogen element bonded to the transition metal element may form a heterocycle with a plurality of carbons of the three-dimensional ordered mesoporous carbon structure.

According to one embodiment, the single-atom catalyst may further include silicon, in which each of the three or more nitrogen elements and the one or more silicon elements may be bonded to the transition metal element, and the nitrogen element and the silicon element bonded to the transition metal element may forma heterocycle with a plurality of carbons of the three-dimensional ordered mesoporous carbon structure.

According to one embodiment, the single-atom catalyst structure may have no peak corresponding to transition metal particles and transition metal oxide particles shown in XRD analysis.

To solve the above technical objects, the present invention may provide a cathode electrode.

According to one embodiment, the cathode electrode the single-atom catalyst fuel according to the embodiments described above.

To solve the above technical objects, the present application may provide a fuel cell.

According to one embodiment, the cathode electrode the single-atom catalyst fuel according to the embodiments described above.

According to an embodiment of the present invention, the single-atom catalyst structure may include a three-dimensional ordered mesoporous carbon structure and a single-atom catalyst doped inside the three-dimensional ordered mesoporous carbon structure. The single-atom catalyst may include transition metal, nitrogen, and carbon, and thus the single-atom catalyst structure may have an enhanced oxygen reduction reaction activity.

In addition, according to one embodiment, the single-atom catalyst structure may further include silicon, and thus may have an enhanced oxygen reduction reaction activity.

Furthermore, the method for preparing a single-atom catalyst structure may include preparing a three-dimensional ordered mesoporous carbon structure, activating the three-dimensional ordered mesoporous carbon structure, and preparing a single-atom catalyst structure by doping a single-atom catalyst, including transition metal, nitrogen, and carbon, in the activated three-dimensional carbon structure. Accordingly, the three-dimensional ordered mesoporous carbon structure including mesopores having various sizes may be used as a catalyst support, and the formation of micropores in the three-dimensional ordered mesoporous carbon structure may be controlled through a carbon dioxide activation process. Thus, a single-atom catalyst structure capable of increasing an active point of the catalyst and facilitating mass transfer may be prepared.

In addition, the single-atom catalyst structure may have along lifespan and an excellent effect of oxygen reduction reaction, include a very small amount of transition metal, silicon, nitrogen, and carbon, and may not use platinum, thereby having low preparation costs and being easily mass-produced.

### BRIEF DESCRIPTION OF THE DRAWINGS

FIG. 1 is a flowchart for explaining a method for preparing a single-atom catalyst structure according to an embodiment of the present invention.

FIG. 2 is a flowchart for explaining preparing a three-dimensional ordered mesoporous carbon structure in the method for preparing a single-atom catalyst structure according to an embodiment of the present invention.

FIG. 3 is a view for explaining a three-dimensional ordered mesoporous carbon structure according to an embodiment of the present invention.

FIG. 4 is a flowchart for explaining preparing a single-atom catalyst structure according to an embodiment of the present invention.

FIG. 5 is a view showing a composite mixture according to an embodiment of the present invention.

FIG. 6 is a view showing a single-atom catalyst structure according to an embodiment of the present invention.

FIG. 7 is views showing SEM and TEM images of Experimental Examples 1 to 4.

FIG. 8 is graphs showing the results of measuring specific surface areas of Experimental Examples 3 to 6.

FIG. 9 is graphs showing a pore distribution of Experimental Examples 3 to 6.

FIG. 10 is graphs showing the results of measuring specific surface areas and a pore distribution with regard to single-atom catalyst structures according to Experimental Examples 8 and 9.

FIG. 11 is an SEM image, the results of measuring a specific surface area, and the results of analyzing a pore distribution with regard to a single-atom catalyst structure according to Experimental Example 7.

FIG. 12 is a graph showing the results of XRD analysis of single-atom catalyst structures according to Experimental Examples 7 to 9.

FIG. 13 is SEM and TEM images and graphs showing the results of EDS mapping with regard to single-atom catalyst structures according to Experimental Examples 8 and 9.

FIG. 14 is views showing HAADF images of a single-atom catalyst structure according to Experimental Example 9.

FIG. 15 is a graph showing the results of EELS analysis of a single-atom catalyst structure according to Experimental Example 9.

FIG. 16 is graphs showing the results of measuring specific surface areas and the results of analyzing a pore distribution with regard to single-atom catalyst structures according to Experimental Examples 9 and 10.

FIG. 17 is graphs showing the results of XPS analysis of single-atom catalyst structures according to Experimental Examples 8 and 9.

FIG. 18 is a graph showing an N functional group distribution of single-atom catalyst structures according to Experimental Examples 8 and 9.

FIG. 19 is graphs showing the results of XANES and EXAFS of single-atom catalyst structures according to Experimental Examples 8 to 9.

FIG. 20 is graphs showing the results of XPS scan and Si spectrum analysis of single-atom catalyst structures according to Experimental Examples 8 and 9.

FIG. 21 is graphs showing the results of CV analysis under a nitrogen and oxygen atmosphere with regard to single-atom catalyst structures according to Experimental Examples 7 to 9.

FIG. 22 is a graph showing the results of LSV of single-atom catalyst structures according to Experimental Examples 7 to 9.

FIG. 23 is a graph showing the results of pore volume and kinetic current density analysis with regard to single-atom catalyst structures according to Experimental Examples 7 to 9.

FIG. 24 is a graph showing an electron transfer number of single-atom catalyst structures according to Experimental Examples 7 to 9.

FIG. 25 is graphs showing the results of LSV of single-atom catalyst structures according to Experimental Examples 7 to 9.

FIG. 26 is graphs showing an electron transfer number of single-atom catalyst structures according to Experimental Examples 7 to 9.

FIG. 27 is graphs showing the results of LSV and the results of an electron transfer number with regard to a single-atom catalyst structure according to Experimental Example 10.

FIG. 28 is graphs showing the results of a methanol poisoning experiment and the results of evaluating long-term durability with regard to single-atom catalyst structures according to Experimental Examples 8 and 9.

FIG. 29 is graphs showing the results of analyzing ZAB performance according to a weight of single-atom catalyst structures according to Experimental Examples 8 to 9.

FIG. 30 is graphs showing the results of analyzing ZAB performance according to an amount of catalyst used in single-atom catalyst structures according to Experimental Examples 8 to 9.

FIG. 31 is graphs showing the results of analyzing ZAB performance according to a rate capability of single-atom catalyst structures according to Experimental Examples 8 and 9.

### DETAILED DESCRIPTION OF THE EXEMPLARY EMBODIMENTS

Hereinafter, preferred embodiments of the present invention will be described in detail with reference to the accompanying drawings. However, the technical idea of the present invention is not limited to the embodiments described herein and may be embodied in other forms. Rather, the embodiments introduced herein are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, the thicknesses of membranes and areas are exaggerated for efficient description of the technical contents.

Further, in the various embodiments of the present invention, the terms such as first, second, and third are used to describe various elements, but the elements are not limited to the terms. These terms are used only to distinguish one element from another element. Accordingly, an element mentioned as a first element in one embodiment may be mentioned as a second element in another embodiment. Each of the embodiments described and illustrated herein also include their complementary embodiments. Further, the term “and/or” in the present specification is used to include at least one of the elements enumerated in the specification.

In the specification, the terms of a singular form may include plural forms unless otherwise specified. Further, the terms “including” and “having” are used to designate that the features, the numbers, the steps, the elements, or combinations thereof described in the specification are present, and are not to be understood as excluding the possibility that one or more other features, numbers, steps, elements, or combinations thereof may be present or added. In addition, the term “connection” used herein may include the meaning of indirectly connecting a plurality of components, and directly connecting a plurality of components.

Further, in the following description of the present invention, a detailed description of known functions and configurations incorporated herein will be omitted when it may make the subject matter of the present invention unnecessarily unclear.

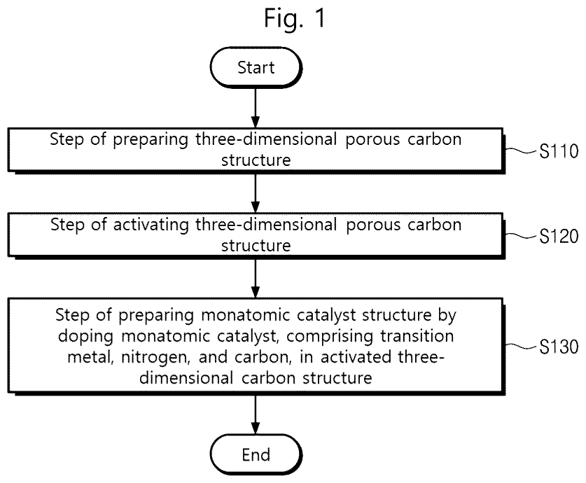

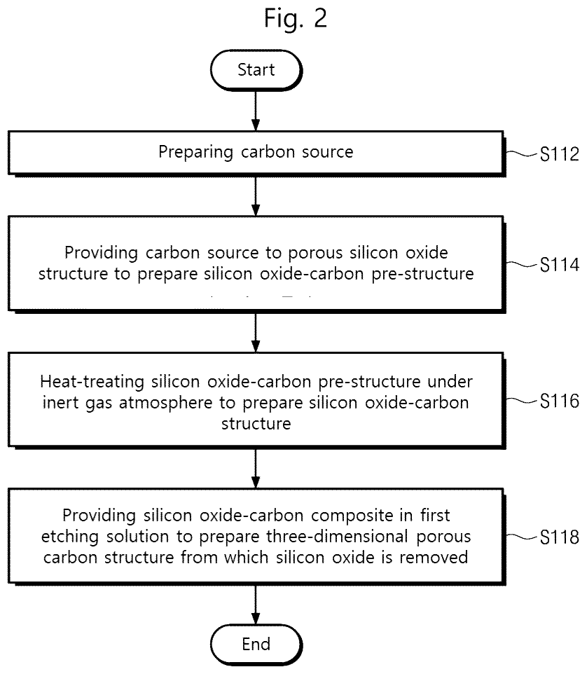

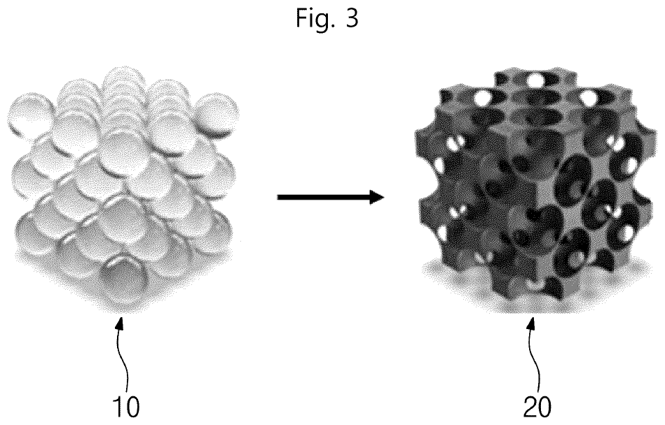

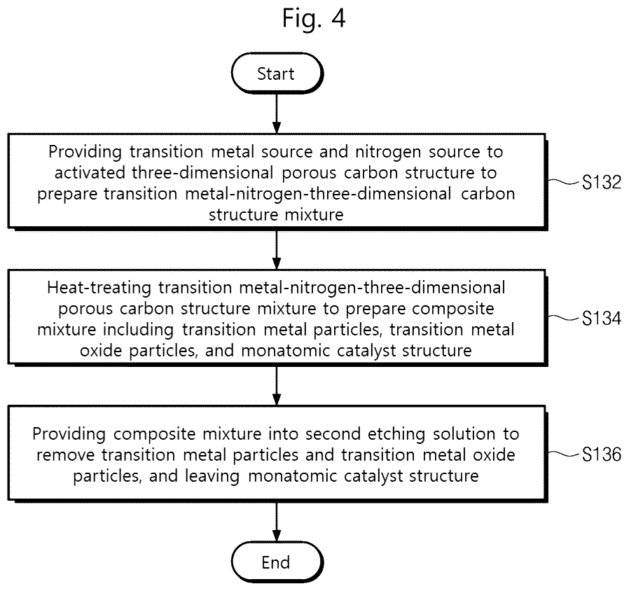

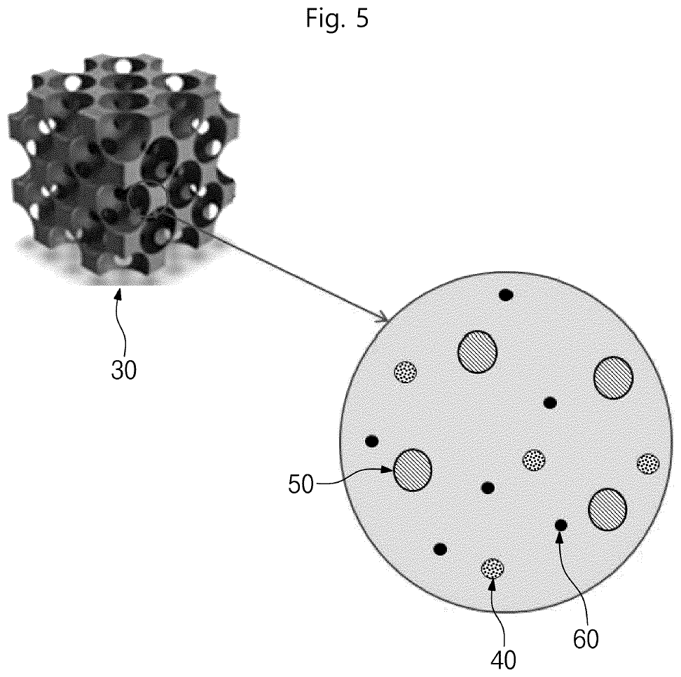

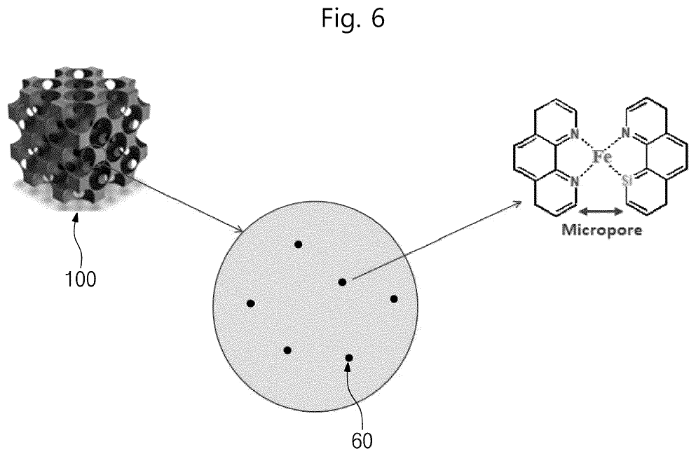

FIG. 1 is a flowchart for explaining a method for preparing a single-atom catalyst structure 100 according to an embodiment of the present invention. FIG. 2 is a flowchart for explaining preparing a three-dimensional ordered mesoporous carbon structure 20 in the method for preparing a single-atom catalyst structure 100 according to an embodiment of the present invention. FIG. 3 is a view for explaining a three-dimensional ordered mesoporous carbon structure according to an embodiment of the present invention. FIG. 4 is a flowchart for explaining preparing a single-atom catalyst structure 100 according to an embodiment of the present invention. FIG. 5 is a view showing a composite mixture 30 according to an embodiment of the present invention. FIG. 6 is a view showing a single-atom catalyst structure according to an embodiment of the present invention.

Referring to FIGS. 1, 2 and 3, a three-dimensional ordered mesoporous carbon structure 20 may be prepared (S110).

The three-dimensional ordered mesoporous carbon structure 20 may be a carbon structure including pores having various sizes. For example, the three-dimensional ordered mesoporous carbon structure may be a carbon structure including macropores which are 80 nm or less.

In addition, for example, the three-dimensional ordered mesoporous carbon structure 20 may further include hydrogen and oxygen in addition to carbon. Alternatively, as another example, the three-dimensional ordered mesoporous carbon structure 20 may further include hydrogen, oxygen and silicon in addition to carbon.

According to one embodiment, the three-dimensional ordered mesoporous carbon structure 20 may be prepared through a method of providing a carbon source to a porous silicon oxide structure 10 (FCC packed SiO₂ arrays), heat-treating the same, and removing the porous silicon oxide structure 10. Hereinafter, a method for preparing the three-dimensional ordered mesoporous carbon structure 20 will be described in more detail with reference to FIG. 2.

As shown in FIG. 2, the preparing of the three-dimensional ordered mesoporous carbon structure 20 may include preparing a carbon source (S112), providing the carbon source to the porous silicon oxide structure 10 to prepare a silicon oxide-carbon pre-structure (S114), heat-treating the silicon oxide-carbon pre-structure under an inert gas atmosphere to prepare a silicon oxide-carbon structure (S116), and providing the silicon oxide-carbon composite in a first etching solution to prepare the three-dimensional ordered mesoporous carbon structure 20 from which silicon oxide is removed (S118).

Referring to FIGS. 2 and 3, the carbon source may be provided to the porous silicon oxide structure 10 to prepare the silicon oxide-carbon pre-structure (S114).

For example, the carbon source may include furfuryl alcohol. Alternatively, as another example, the carbon source may include a pyrrole solution.

The porous silicon oxide structure 10 may be formed of a plurality of silicon oxide particles. For example, the porous silicon oxide structure 10 may be formed by arranging and aggregating the silicon oxide particles in a face-centered cubic (FCC) structure. For example, the silicon oxide particle may have a size of 20 nm to 80 nm.

According to one embodiment, in the preparing of the silicon oxide-carbon pre-structure (S114), a polymerization catalyst and the carbon source may be provided to the porous silicon oxide structure 10. For example, a mixed solution of the carbon source and the polymerization catalyst may be provided to the porous silicon oxide structure 10.

According to one embodiment, the polymerization catalyst may include an acidic solution. For example, the polymerization catalyst may include oxalic acid. Alternatively, as another example, the polymerization catalyst may include at least one of acetic acid and sodium hydrogen carbonate.

When the mixed solution obtained by mixing the carbon source and the polymerization catalyst is provided to the porous silicon oxide structure 10, the carbon source and the polymerization catalyst may be infiltrated into the pores of the porous silicon oxide structure, and carbon of the carbon source may be polymerized to prepare the silicon oxide-carbon pre-structure.

Referring to FIG. 2, the silicon oxide-carbon pre-structure may be heat-treated under an inert gas atmosphere to prepare the silicon oxide-carbon structure (S116).

According to one embodiment, the silicon oxide carbon pre-structure may be heat-treated at 800° C. in the inert gas atmosphere for three hours. For example, the silicon oxide carbon pre-structure may be heat-treated under a nitrogen atmosphere. Accordingly, a carbon polymer in the silicon oxide-carbon pre-structure may be cured to prepare the silicon oxide-carbon structure.

Referring to FIGS. 2 and 3, the silicon oxide-carbon composite may be provided in first etching solution to prepare the three-dimensional ordered mesoporous carbon structure 20 from which silicon oxide is removed (S118).

The first etching solution may be provided to the silicon oxide-carbon composite, so that the silicon oxide may be selectively removed from the silicon oxide-carbon composite. In other words, the silicon oxide may be selectively removed by the first etching solution from the silicon oxide-carbon composite and carbon may remain.

According to one embodiment, the first etching solution may include alkaline solution. For example, the first etching solution may include potassium hydroxide. Alternatively, as another example, the first etching solution may include at least one of hydrogen fluoride and sodium hydroxide.

According to one embodiment, the preparing of the three-dimensional ordered mesoporous carbon structure 20 may include controlling a temperature of the first etching solution to control presence and absence of silicon in the three-dimensional ordered mesoporous carbon structure 20 and a ratio of residual silicon in the three-dimensional ordered mesoporous carbon structure 20.

In other words, the presence or absence of silicon and the amount of silicon in the single-atom catalyst structure 100 to be described later may be controlled according to a temperature of the first etching solution. Specifically, when the temperature of the first etching solution is relatively high (e.g., 100° C.), silicon may be substantially absent in the three-dimensional ordered mesoporous carbon structure 20, or a ratio of residual silicon may be low, and thus the single-atom catalyst structure 100 to be described later may not include silicon. On the contrary, when the temperature of the first etching solution is relatively low (e.g., room temperature), a ratio of residual silicon in the three-dimensional ordered mesoporous carbon structure 20 may be high, and thus the single-atom catalyst structure 100 to be described later may include silicon.

Subsequently, referring to FIG. 1, the three-dimensional ordered mesoporous carbon structure 20 prepared by the method described with reference to FIGS. 2 and 3 may be activated (S120).

According to one embodiment, the three-dimensional ordered mesoporous carbon structure 20 may be activated under an atmosphere including carbon dioxide. For example, the three-dimensional ordered mesoporous carbon structure 20 may be activated under an atmosphere in which a mixture of 900 cc/min of nitrogen gas and 300 cc/min of carbon dioxide is provided. In addition, for example, the three-dimensional ordered mesoporous carbon structure 20 may be activated at 900° C. for 20 minutes.

When the three-dimensional ordered mesoporous carbon structure is activated with carbon dioxide, micropores which are 2 nm or less may be formed in the three-dimensional ordered mesoporous carbon structure 20. Accordingly, the activated three-dimensional ordered mesoporous carbon structure may simultaneously include mesopores and micropores. In other words, the three-dimensional ordered mesoporous carbon structure 20 may be activated to increase a specific surface area.

In addition, in the activating of the three-dimensional ordered mesoporous carbon structure 20 (S120), the higher a concentration of carbon dioxide gas is, the faster and more effective the activation may be performed.

Subsequently, referring to FIGS. 1 and 4 to 6, the single-atom catalyst structure may be prepared by doping the single-atom catalyst, including transition metal, nitrogen, and carbon in the activated three-dimensional carbon structure (S130).

Referring to FIG. 6, the single-atom catalyst structure 100 may include the activated three-dimensional ordered mesoporous carbon structure and a single-atom catalyst 60 doped inside the three-dimensional ordered mesoporous carbon structure, in which the single-atom catalyst 60 may include transition metal, nitrogen, and carbon.

According to one embodiment, in the single-atom catalyst 60, each of the three or more nitrogen elements may be bonded to the transition metal element. In addition, the nitrogen element bonded to the transition metal element may forma heterocycle with a plurality of carbons of the three-dimensional ordered mesoporous carbon structure. For example, the transition metal may include iron.

According to another embodiment, as described above, when the temperature of the first etching solution is relatively low, the single-atom catalyst 60 may further include silicon. In other words, the single-atom catalyst 60 may include transition metal, nitrogen, carbon, and silicon. In this case, each of the three or more nitrogen elements and the one or more silicon elements may be bonded to the transition metal element. In addition, the nitrogen element and the silicon element, which are bonded to the transition metal element, may form a heterocycle with a plurality of carbons of the three-dimensional ordered mesoporous carbon structure 20.

As shown in FIG. 4, the preparing of the single-atom catalyst structure 100 may include providing a transition metal source and a nitrogen source to the activated three-dimensional ordered mesoporous carbon structure to prepare a transition metal-nitrogen-three-dimensional carbon porous structure mixture (S132), heat-treating the transition metal-nitrogen-three-dimensional ordered mesoporous carbon structure mixture to prepare a composite mixture 30 including transition metal particles 40, transition metal oxide particles 50, and the single-atom catalyst 60 (S134), and providing the composite mixture 30 into a second etching solution to remove the transition metal particles 40 and the transition metal oxide particles 50, and leaving the single-atom catalyst 60 (S136).

Referring to FIGS. 4 and 5, the transition metal source and the nitrogen source may be provided to the activated three-dimensional ordered mesoporous carbon structure to prepare the transition metal-nitrogen-three-dimensional carbon structure mixture (S132).

According to one embodiment, a transition metal-nitrogen precursor mixed solution obtained by mixing the transition metal source, the nitrogen source, and solvent may be provided to the activated three-dimensional ordered mesoporous carbon structure to prepare a transition metal-nitrogen-three-dimensional carbon structure mixture.

When the transition metal-nitrogen precursor mixed solution obtained by mixing the transition metal source, the nitrogen source, and the solvent is provided to the activated three-dimensional ordered mesoporous carbon structure, the mixed solution may be infiltrated into the pores of the activated three-dimensional ordered mesoporous carbon structure to prepare the transition metal-nitrogen-three-dimensional carbon structure mixture.

For example, the transition metal source may include FeCl₂·4H₂O. Alternatively, as another example, the transition metal source may include at least one of Fe(NO₃)₂·9H2O and FeCl₃·6H2O.

According to one embodiment, the nitrogen source may include 10-phenanthroline.

According to one embodiment, the solvent may include ethanol. Alternatively, as another example, the solvent may include at least one of methanol and tetrahydrofuran (THF).

Subsequently, referring to FIGS. 4 and 5, the transition metal-nitrogen-three-dimensional ordered mesoporous carbon structure mixture may be heat-treated to prepare the composite mixture including the transition metal particles 40, the transition metal oxide particles 50, and the single-atom catalyst structure 100 (S134).

According to one embodiment, the transition metal-nitrogen-three-dimensional ordered mesoporous carbon structure mixture may be dried before heat-treating the transition metal-nitrogen-three-dimensional ordered mesoporous carbon structure mixture. For example, the transition metal-nitrogen-three-dimensional ordered mesoporous carbon structure mixture may be dried at 90° C. or higher for one hour.

According to one embodiment, the transition metal-nitrogen-three-dimensional ordered mesoporous carbon structure mixture may be heat-treated under an atmosphere including nitrogen.

For example, the transition metal-nitrogen-three-dimensional ordered mesoporous carbon structure mixture may be heat-treated at 800° C. under a nitrogen atmosphere for one hour.

When the transition metal-nitrogen-three-dimensional ordered mesoporous carbon structure mixture is heat-treated, the single-atom catalyst 60 including the transition metal, the nitrogen, and the carbon may be doped in the activated three-dimensional ordered mesoporous carbon structure. In addition, the transition metal source infiltrated into the surface and pores of the activated three-dimensional ordered mesoporous carbon structure may be heat-treated to form the transition metal particles 40 and the transition metal oxide particles 50. In other words, when the transition metal-nitrogen-three-dimensional ordered mesoporous carbon structure mixture is heat-treated, impurities including the transition metal particles 40 and the transition metal oxide particles 50 may be generated together in addition to the single-atom catalyst 60.

Subsequently, referring to FIGS. 1 and 4 to 6, the composite mixture 30 may be provided in the second etching solution to remove the transition metal particles 40 and the transition metal oxide particles 50, and the single-atom catalyst 60 may remain to prepare the single-atom catalyst structure 100 (S136).

When the composite mixture 30 is provided in the second etching solution, impurities including the transition metal particles 40 and the transition metal oxide particles 50 formed on the surface and/or in the pores of the activated three-dimensional ordered mesoporous carbon structure may be removed by the second etching solution. On the contrary, the single-atom catalyst 60 doped in the activated three-dimensional ordered mesoporous carbon structure may not be removed by the second etching solution and may remain in the activated three-dimensional ordered mesoporous carbon structure to form the single-atom catalyst structure 100. In other words, the transition metal in a single-atom state, which is not substantially in the state of the transition metal particles 40 and the transition metal oxide particles 50, may be provided in the single-atom catalyst structure 100.

According to one embodiment, the second etching solution may include an acidic solution. For example, the second etching solution may include H₂SO₄. Alternatively, as another example, the second etching solution may include at least one of HCl and HNO₃.

According to one embodiment, the composite mixture 30 may be provided in the second etching solution to remove the transition metal particles 40 and the transition metal oxide particles 50, and the single-atom catalyst structure 100 may remain and may be further heat-treated.

A degree of crystallinity of carbon in the composite mixture 30 may be increased by the additional heat treatment. As a result, electrical conductivity may be improved.

For example, the additional heat treatment may be performed at 800° C. under a nitrogen atmosphere for one hour.

The activated three-dimensional ordered mesoporous carbon structure may include mesopores and micropores and thus have a large specific surface area. Accordingly, when the activated three-dimensional ordered mesoporous carbon structure is used as a support for the single-atom catalyst 60, a large amount of the monomeric structural catalyst 60 may be uniformly doped in the activated three-dimensional ordered mesoporous carbon structure, thereby exhibiting an excellent catalytic activity effect. In addition, the activated three-dimensional ordered mesoporous carbon structure may include pores having various sizes, thereby exhibiting an effect of facilitating mass transfer of reactants and products of a catalytic reaction.

In other words, the single-atom catalyst structure 100 may include the activated three-dimensional ordered mesoporous carbon structure and the single-atom catalyst 60 doped inside the three-dimensional ordered mesoporous carbon structure, in which the single-atom catalyst 60 may include transition metal, nitrogen, and carbon, thereby exhibiting an excellent oxygen reduction reaction activity.

In addition, according to one embodiment, the single-atom catalyst structure 100 may further include silicon, and thus may have an enhanced oxygen reduction reaction activity.

In addition, the single-atom catalyst structure may have along lifespan and an excellent effect of oxygen reduction reaction, include a very small amount of transition metal, silicon, nitrogen, and carbon, and may not use platinum, thereby having low preparation costs and being easily mass-produced.

Hereinafter, specific experimental embodiments and the results of evaluating properties will be described with regard to the single-atom catalyst structure according to an embodiment of the present invention.

### Preparation of Porous Silicon Oxide Structure According to Experimental Example 1 (Silicon Oxide Particle Size of 36±3 nm)

150 ml of deionized water, 0.15 g of L-lysine, and 20 g of tetraethylorthosilicate (TEOS) were mixed and stirred for about 15 minutes.

The resulting mixture was placed in a high-density polypropylene bottle and stirred for 48 hours while maintaining 90° C. in a sealed state. After that, 20 g of the TEOS was added and stirred for 48 hours.

The stirred solution was placed in an empty container and slowly dried in an oven at 90° C. to pack the silicon oxide particles into FCC.

The resulting product was heat-treated at 700° C. under an air atmosphere for three hours to prepare a porous silicon oxide structure according to Experimental Example 1 from which a residual organic matter was removed.

### Preparation of Porous Silicon Oxide Structure According to Experimental Example 2 (Silicon Oxide Particle Size of 62±4 nm)

150 ml of deionized water, 0.15 g of L-lysine, and 20 g of tetraethylorthosilicate (TEOS) were mixed and stirred for about 15 minutes. Then, the resulting mixture was placed in a high-density polypropylene bottle and stirred for 48 hours while maintaining 90° C. in a sealed state. After that, 20 g of the TEOS was added and stirred for 48 hours.

40 g of the TEOS was added and stirred for 48 hours, after which g of the TEOS was added again and stirred for 48 hours, and finally g of the TEOS was added and stirred for 48 hours (a total of 160 g of the TEOS was added for a total of eight days).

The stirred solution was placed in an empty container and slowly dried in an oven at 90° C. to pack SiO₂ particles into FCC.

The resulting product was heat-treated at 700° C. under an air atmosphere for three hours to prepare a porous silicon oxide structure according to Experimental Example 2 from which a residual organic matter was removed.

### Preparation of Three-Dimensional Ordered Mesoporous Carbon Structure According to Experimental Example 3 (3 DMC 25)

20 g of furfuryl alcohol and 0.1 g of oxalic acid were mixed and sufficiently stirred to prepare a carbon source. In addition, the carbon source was dropped onto 10 g of the porous silicon oxide structure prepared according to Experimental Example 1, and thus the carbon source permeated into the porous silicon oxide structure. After waiting for three hours to sufficiently permeate, the resulting product was placed in a conical tube with a lid closed, and then polymerized in an oven at 90° C. for 12 hours to prepare a silicon oxide-carbon pre-structure.

After that, heat treatment was performed at 800° C. for three hours in a furnace under a nitrogen atmosphere to prepare a silicon oxide-carbon structure.

The silicon oxide-carbon structure was provided in 6 M KOH at room temperature (25° C.) and stirred to prepare the three-dimensional ordered mesoporous carbon structure according to Experimental Example 3 with silicon partially removed. At this time, the KOH was replaced every 24 hours and stirred for 72 hours.

Preparation of three-dimensional ordered mesoporous carbon structure according to Experimental Example 4 (3 DMC 50) g of furfuryl alcohol and 0.1 g of oxalic acid were mixed and sufficiently stirred to prepare a carbon source. In addition, the carbon source was dropped onto 10 g of the porous silicon oxide structure prepared according to Experimental Example 2, and thus the carbon source permeated into the porous silicon oxide structure. After waiting for three hours to sufficiently permeate, the resulting product was placed in a conical tube with a lid closed, and then polymerized in an oven at 90° C. for 12 hours to prepare a silicon oxide-carbon pre-structure.

After that, heat treatment was performed at 800° C. for three hours in a furnace under a nitrogen atmosphere to prepare a silicon oxide-carbon structure.

The silicon oxide-carbon structure was provided in 6 M KOH at room temperature (25° C.) and stirred to prepare the three-dimensional ordered mesoporous carbon structure according to Experimental Example 4 with silicon partially removed. At this time, the KOH was replaced every 24 hours and stirred for 72 hours.

### Preparation of Activated Three-Dimensional Ordered Mesoporous Carbon Structure According to Experimental Example 5 (3 DMC 25a)

500 g of the three-dimensional ordered mesoporous carbon structure according to Experimental Example 3 was put into a furnace and activated at 900° C. for 20 minutes while providing N₂ gas at a flow rate of 900 cc/min and CO₂ at a flow rate of 300 cc/min, thereby preparing the activated three-dimensional ordered mesoporous carbon structure according to Experimental Example 5.

### Preparation of Activated Three-Dimensional Ordered Mesoporous Carbon Structure According to Experimental Example 6 (3 DMC 50a)

500 g of the three-dimensional ordered mesoporous carbon structure according to Experimental Example 4 was put into a furnace and activated at 900° C. for 20 minutes while providing N₂ gas at a flow rate of 900 cc/min and CO₂ at a flow rate of 300 cc/min, thereby preparing the activated three-dimensional ordered mesoporous carbon structure according to Experimental Example 6.

### Preparation of single-atom catalyst structure according to Experimental Example 7 (FeSiNC 25)

150 mg of FeCl₂·4H2O and 500 mg of 1,10-phenanthroline were added to 5 mL of ethanol and stirred for 30 minutes to prepare a precursor mixed solution.

Each 0.5 ml of the precursor mixed solution was added to 0.15 g of the three-dimensional ordered mesoporous carbon structure according to Experimental Example 3 and stirred to prepare a transition metal-nitrogen-three-dimensional ordered mesoporous carbon structure mixture.

After that, the transition metal-nitrogen-three-dimensional ordered mesoporous carbon structure mixture was dried in an oven at ° C. for one hour, put into a furnace, and heat-treated at 800° C. under a nitrogen atmosphere for one hour to prepare a composite mixture including transition metal particles, transition metal oxide particles, and a single-atom catalyst structure.

Then, the composite mixture was provided in 0.5 M of H₂SO₄, and subjected to acid treatment at 80° C. for 12 hours to remove the transition metal particles and the transition metal oxide particles. After that, a re-heat treatment was performed at 80° C. under a nitrogen atmosphere for one hour to prepare the single-atom catalyst structure according to Experimental Example 7.

### Preparation of Single-Atom Catalyst Structure According to Experimental Example 8 (FeSiNC 25a)

150 mg of FeCl₂·4H2O and 500 mg of 1,10-phenanthroline were added to 5 mL of ethanol and stirred for 30 minutes to prepare a precursor mixed solution.

Each 0.5 ml of the precursor mixed solution was added to 0.15 g of the activated three-dimensional ordered mesoporous carbon structure according to Experimental Example 5 and stirred to prepare a transition metal-nitrogen-three-dimensional ordered mesoporous carbon structure mixture.

After that, the transition metal-nitrogen-three-dimensional ordered mesoporous carbon structure mixture was dried in an oven at 90° C. for one hour, put into a furnace, and heat-treated at 800° C. under a nitrogen atmosphere for one hour to prepare a composite mixture including transition metal particles, transition metal oxide particles, and a single-atom catalyst structure.

Then, the composite mixture was provided in 0.5 M of H₂SO₄, and subjected to acid treatment at 80° C. for 12 hours to remove the transition metal particles and the transition metal oxide particles. After that, a re-heat treatment was performed at 80° C. under a nitrogen atmosphere for one hour to prepare the single-atom catalyst structure according to Experimental Example 8.

### Preparation of Single-Atom Catalyst Structure According to Experimental Example 9 (FeSiNC 50a)

150 mg of FeCl₂·4H2O and 500 mg of 1,10-phenanthroline were added to 5 mL of ethanol and stirred for 30 minutes to prepare a precursor mixed solution.

Each 0.5 ml of the precursor mixed solution was added to 0.15 g of the activated three-dimensional ordered mesoporous carbon structure according to Experimental Example 6 and stirred to prepare a transition metal-nitrogen-three-dimensional ordered mesoporous carbon structure mixture.

After that, the transition metal-nitrogen-three-dimensional ordered mesoporous carbon structure mixture was dried in an oven at ° C. for one hour, put into a furnace, and heat-treated at 800° C. under a nitrogen atmosphere for one hour to prepare a composite mixture including transition metal particles, transition metal oxide particles, and a single-atom catalyst structure.

Then, the composite mixture was provided in 0.5 M of H₂SO₄, and subjected to acid treatment at 80° C. for 12 hours to remove the transition metal particles and the transition metal oxide particles. After that, a re-heat treatment was performed at 80° C. under a nitrogen atmosphere for one hour to prepare the single-atom catalyst structure according to Experimental Example 9.

### Preparation of Single-Atom Catalyst Structure According to Experimental Example 10 (FeNC 50a)

20 g of furfuryl alcohol and 0.1 g of oxalic acid were mixed and sufficiently stirred to prepare a carbon source. In addition, the carbon source was dropped onto 10 g of the porous silicon oxide structure prepared according to Experimental Example 2, and thus the carbon source permeated into the porous silicon oxide structure. After waiting for three hours to sufficiently permeate, the resulting product was placed in a conical tube with a lid closed, and then polymerized in an oven at 90° C. for 12 hours to prepare a silicon oxide-carbon pre-structure.

After that, heat treatment was performed at 800° C. for three hours in a furnace under a nitrogen atmosphere to prepare a silicon oxide-carbon structure.

The silicon oxide-carbon structure was provided in 6M KOH at 100° C. and stirred to prepare the three-dimensional ordered mesoporous carbon structure with silicon removed. At this time, the KOH was replaced every 24 hours and stirred for 72 hours. 500 g of the three-dimensional ordered mesoporous carbon structure was put into a furnace and activated at 900° C. for 20 minutes while providing N₂ gas at a flow rate of 900 cc/min and CO₂ at a flow rate of 300 cc/min, thereby preparing the activated three-dimensional ordered mesoporous carbon structure according to Experimental Example 5.

150 mg of FeCl₂·4H₂O and 500 mg of 1,10-phenanthroline were added to 5 mL of ethanol and stirred for 30 minutes to prepare a precursor mixed solution.

Each 0.5 ml of the precursor mixed solution was added to 0.15 g of the three-dimensional ordered mesoporous carbon structure and stirred to prepare a transition metal-nitrogen-three-dimensional ordered mesoporous carbon structure mixture.

After that, the transition metal-nitrogen-three-dimensional ordered mesoporous carbon structure mixture was dried in an oven at 90° C. for one hour, put into a furnace, and heat-treated at 800° C. under a nitrogen atmosphere for one hour to prepare a composite mixture including transition metal particles, transition metal oxide particles, and a single-atom catalyst structure.

Then, the composite mixture was provided in 0.5 M H₂SO₄, and subjected to acid treatment at 80° C. for 12 hours to remove the transition metal particles and the transition metal oxide particles. After that, a re-heat treatment was performed at 80° C. under a nitrogen atmosphere for one hour to prepare the single-atom catalyst structure according to Experimental Example 10.

TABLE 1

| | Experimental | Experimental | Experimental | Experimental |
|---|---|---|---|---|
| Classification | Example 7 | Example 8 | Example 9 | Example 10 |
| Silicon oxide particle size | 36 ± 3 nm | 36 ± 3 nm | 62 ± 4 nm | 62 ± 4 nm |
| 1st etching solution | 6M KOH, | 6M KOH, | 6M KOH, | 6M KOH, |
| | 25° C., 72 hours | 25° C., 72 hours | 25° C., 72 hours | 100° C., 72 hours |
| 3D ordered mesoporous | 0.15 g | 0.15 g | 0.15 g | 0.15 g |
| carbon structure | | | | |
| Activation process | X | O | O | O |
| Transition metal source | FeCl₂•4H₂O, | FeCl₂•4H₂O, | FeCl₂•4H₂O, | FeCl₂•4H₂O, |
| | 150 mg | 150 mg | 150 mg | 150 mg |
| Nitrogen source | 1,10- | 1,10- | 1,10- | 1,10- |
| | phenanthroline, | phenanthroline, | phenanthroline, | phenanthroline, |
| | 500 mg | 500 mg | 500 mg | 500 mg |
| Solvent | Ethanol, 5 mL | Ethanol, 5 mL | Ethanol, 5 mL | Ethanol, 5 mL |
| Drying | 90° C., 1 hour | 90° C., 1 hour | 90° C., 1 hour | 90° C., 1 hour |
| Heat-treatment | Nitrogen | Nitrogen | Nitrogen | Nitrogen |
| | atmosphere, | atmosphere, | atmosphere, | atmosphere, |
| | 800° C., 1 hour | 800° C., 1 hour | 800° C., 1 hour | 800° C., 1 hour |
| Second etching solution | 0.5M H₂SO₄, | 0.5M H₂SO₄, | 0.5M H₂SO₄, | 0.5M H₂SO₄, |
| | 80° C., 12 hours | 80° C., 12 hours | 80° C., 12 hours | 80° C., 12 hours |
| Re-heat treatment | Nitrogen | Nitrogen | Nitrogen | Nitrogen |
| | atmosphere, | atmosphere, | atmosphere, | atmosphere, |
| | 800° C., 1 hour | 800° C., 1 hour | 800° C., 1 hour | 800° C., 1 hour |

Oxygen Activity Measurement

An oxygen reduction reaction (ORR) of the single-atom catalyst structures prepared according to above Experimental Examples 7 to 10 was measured.

5 mg of each of the single-atom catalyst structures, 0.5 ml of 2-propanol, and 50 [symbol] of 5 wt % Nafion were mixed and stirred for 30 minutes to prepare respective catalyst inks. The catalyst ink was dropped onto an RDE electrode having a radius of 0.5 mm and set to load 0.2 mg/cm². Ag/AgCl was used as a reference electrode, Pt wire was used as a counter electrode, and 0.1 M KOH was used as electrolyte.

Cyclic voltammetry (CV) and linear sweep voltammetry (LSV) were measured under the condition of 0.1 to −1.0 V (vs. Ag/AgCl (V)). CV was measured at a rate of 50 mV/s under an oxygen and argon atmosphere, and LSV was measured at a rate of 5 mV/s under an oxygen atmosphere.

In order to calculate a kinetic current and an electron transfer number used in the ORR, the LSV was measured under the condition of 400, 900, 1200, and 1600 rpm, and then calculated using a Koutecky-Levich (K-L) equation. A calculation formula is as follows.

$$\frac{1}{i} = \frac{1}{{i}_{L}} + \frac{1}{{i}_{K}} = \frac{1}{B {ω}^{\frac{1}{2}}} + \frac{1}{{i}_{K}} \\ B = 0.62 {{nFC}_{0} ( {D}_{{O}_{2}} )}^{\frac{2}{3}} {v}^{\frac{- 1}{6}}$$

i is a measured current density, iL is a diffusion limiting current density, and iK is a kinetic current density. ω is an angular velocity and F is Faraday's constant (98485 C/mol). C0 is a bulk oxygen concentration saturated in electrolyte (0.1 M KOH: 1.21×10⁻⁶ mol/cm³). DO is an oxygen diffusion rate in electrolyte (0.1 M KOH: 1.86×10⁻⁵ cm²/s). ν is a kinetic viscosity of 0.01 cm²/s. In a methanol durability test, chronoamperometry was applied at 1600 rpm under a condition of −0.4 V vs Ag/AgCl, and then 1 M methanol was added after 500 seconds. In an accelerated durability test (ADT), the CV was performed at 5000 cycles (50 mV/s) in a range of 0 to −0.4 V vs Ag/AgCl. After the ADT was performed under a nitrogen gas atmosphere, the LSV was measured under the same conditions as above under an oxygen atmosphere (measured at a rate of 5 mV/s).

Battery Output Measurement

In the case of a cathode electrode, a catalyst ink was prepared by adding 10 mg of a single-atom catalyst structure and 0.2 ml of 5 wt % Nafion to 0.8 ml of ethanol and then stirring the resulting mixture for 30 minutes. Each 20 uL of the catalyst ink prepared above was dropped onto a 39 BC carbon gas diffusion layer (GDL) and dried in an oven at 90° C. for 30 minutes.

Zn foil having a thickness of 0.3 mm was used as an anode. An assembly was made using an ECC-air cell (manufactured by: EL-CELL), after which 6 M KOH was used as electrolyte and measured under an oxygen atmosphere. In the case of Zn air battery power output, the obtained current and voltage were calculated using P=1 (current)×V (voltage) equation.

TABLE 2

| | Experimental | Experimental | Experimental | Experimental |
|---|---|---|---|---|
| Classification | Example 3 | Example 4 | Example 5 | Example 6 |
| Vmicro (cm³g⁻¹) | 0.08 | 0.07 | 0.28 | 0.31 |
| Vtot (cm³g⁻¹) | 3.9 | 3.1 | 3.54 | 3.5 |
| SBET (mV) | 1147 | 751 | 1268 | 1050 |
| On set (V) @0.1 mA/cm² * | — | — | — | — |
| Half wave Potential (V)* | — | — | — | — |
| Maximum Electron Transfer Number | — | — | — | — |
| (n) | | | | |
| Maximum Current Density (mAcm⁻²) | — | — | — | — |
| @ 1600 rpm | | | | |
| Fe Content by XPS/EELS (wt %) | — | — | — | — |
| Si Content by XPS/EELS (wt %) | 3.84/− | 3.1/− | 6.01/− | 5.38/− |
| N content by EA/XPS/EELS (wt %) | — | — | — | — |

TABLE 3

| | Experimental | Experimental | Experimental | Experimental | 20 wt % |
|---|---|---|---|---|---|
| Classification | Example 7 | Example 8 | Example 9 | Example 10 | Pt/C |
| Vmicro (cm³g⁻¹) | 0.05 | 0.12 | 0.10 | 0.10 | — |
| Vtot (cm³g⁻¹) | 1.92 | 2.5 | 2.17 | 2.02 | — |
| SBET (mV) | 609 | 788 | 629 | 604 | — |
| On set (V) @0.1 mA/cm² * | 0.024 | 0.052 | 0.056 | 0.049 | 0.046 |
| Half wave Potential (V)* | −0.12 | −0.108 | −0.106 | −0.114 | 0.11 |
| Maximum Electron Transfer | 3.78 | 3.92 | 4.01 | 3.91 | 3.99 |
| Number (n) | | | | | |
| Maximum Current Density | 5.3 | 6.6 | 7.02 | 6.7 | 6.24 |
| (mAcm⁻²) @ 1600 rpm | | | | | |
| Fe Content by XPS/EELS | | 0.55/− | 0.60/0.42 | 0.69/− | — |
| (wt %) | | | | | |
| Si Content by XPS/EELS | — | 0.19/− | 0.69/− | 0.05/− | |
| (wt %) | | | | | |
| N content by EA/XPS/EELS | 1.3/−/− | 1.98/1.68/− | 2.02/1.74/1.13 | — | — |
| (wt %) | | | | | |

Referring to above Table 2, it can be confirmed through XRD analysis that a silicon content of the three-dimensional ordered mesoporous carbon structures according to Experimental Examples 3 and 4 is 3.84 wt % and 3.81 wt %, respectively, and a silicon content of the activated three-dimensional ordered mesoporous carbon structures according to Experimental Examples 5 and 6 is 6.01 wt % and 5.38 wt %, respectively. Accordingly, it can be confirmed that, in a process of providing the silicon oxide-carbon composite in the first etching solution to remove silicon and silicon oxide, some silicon is not removed and remains in the three-dimensional ordered mesoporous carbon structure.

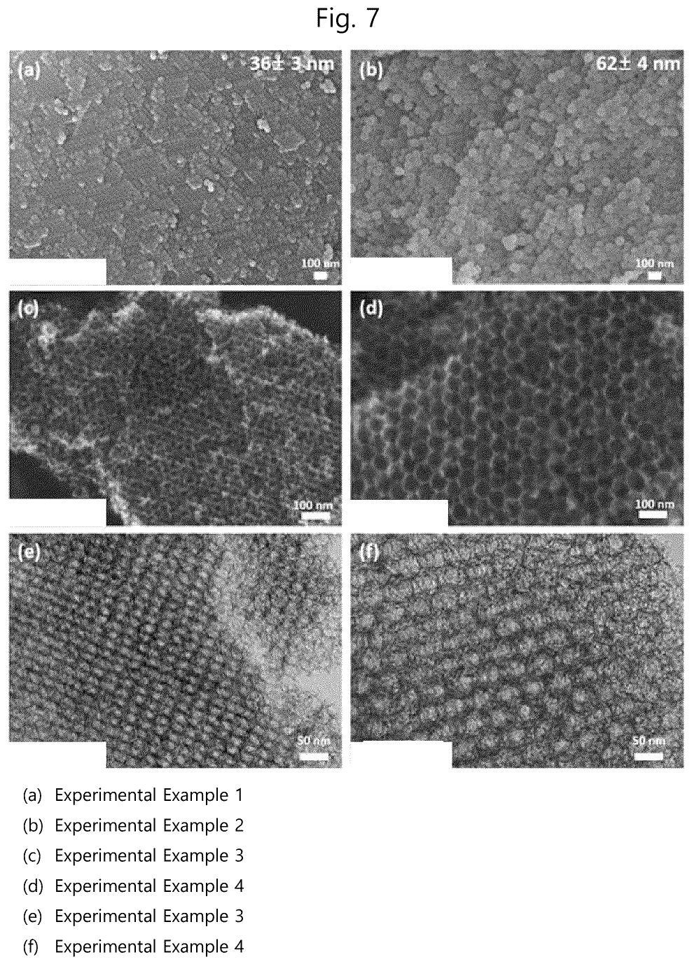

FIG. 7 is views showing SEM and TEM images of Experimental Examples 1 to 4.

Referring to (a) of FIG. 7, it can be confirmed that the porous silicon oxide structure according to Experimental Example 1 has a silicon oxide particle size of 36±3 nm. Referring to (b) of FIG. 7, it can be confirmed that the porous silicon oxide structure according to Experimental Example 2 has a silicon oxide particle size of 62±4 nm.

Referring to (c) and (e) of FIG. 7, each shows SEM and TEM images of the three-dimensional ordered mesoporous carbon structure according to Experimental Example 3 prepared using above Experimental Example 1. Accordingly, it can be confirmed that the pores of the three-dimensional ordered mesoporous carbon structure according to Experimental Example 3 have a size of 25 nm.

Referring to (d) and (f) of FIG. 7, each shows SEM and TEM images of the three-dimensional ordered mesoporous carbon structure according to Experimental Example 4 prepared using above Experimental Example 2. Accordingly, it can be confirmed that the pores of the three-dimensional ordered mesoporous carbon structure according to Experimental Example 4 have a size of 50 nm.

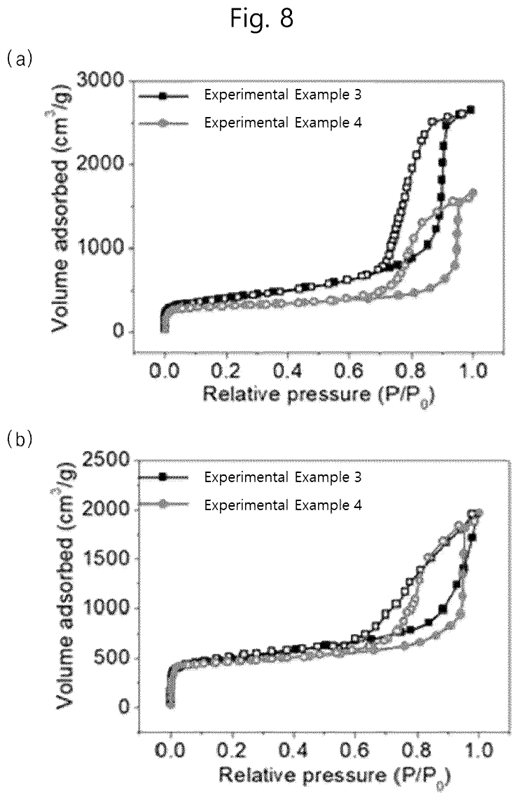

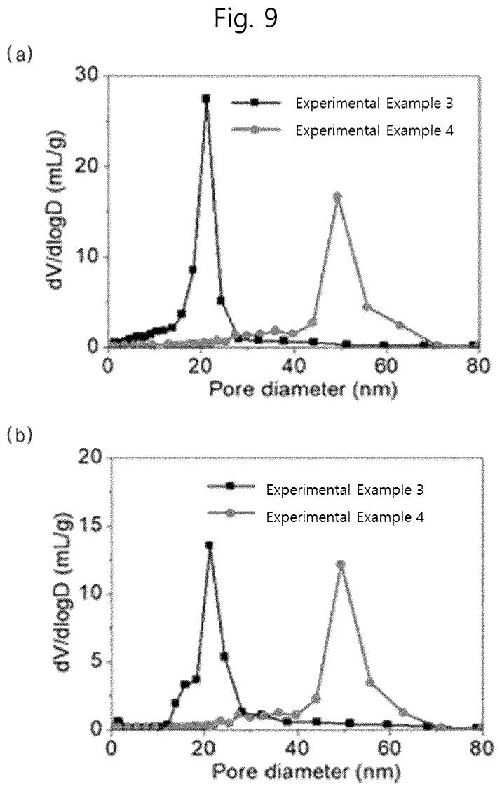

FIG. 8 is graphs showing the results of measuring specific surface areas of Experimental Examples 3 to 6, and FIG. 9 is graphs showing a pore distribution of Experimental Examples 3 to 6. Specifically, FIGS. 8 and 9 show the results of measuring the specific surface area and pore distribution of each of Experimental Examples 3 to 6 using the results of nitrogen isothermal adsorption and the Barrett, Joyner, Halenda (BJH) method under a condition of 77 k, respectively, in order to confirm a change according to a CO₂ activation process.

Referring to FIG. 8, it can be confirmed that the activated three-dimensional ordered mesoporous carbon structures according to Experimental Examples 5 and 6 shown in (b) of FIG. 8 have pores, which are 2 nm or less, developed through the CO₂ activation process and have the specific surface area increased, thereby having an increase in adsorption at 0.1 P/PO pressure, in comparison with the three-dimensional ordered mesoporous carbon structures according to Experimental Examples 3 and 4 shown in (a) of FIG. 8.

Referring to FIG. 9, it can be confirmed that the activated three-dimensional ordered mesoporous carbon structures according to Experimental Examples 5 and 6 shown in (b) of FIG. 9 have a relative decrease in an overall volume of pores, but maintain a main pore structure, in comparison with the three-dimensional ordered mesoporous carbon structures according to Experimental Examples 3 and 4 shown in (a) of FIG. 9.

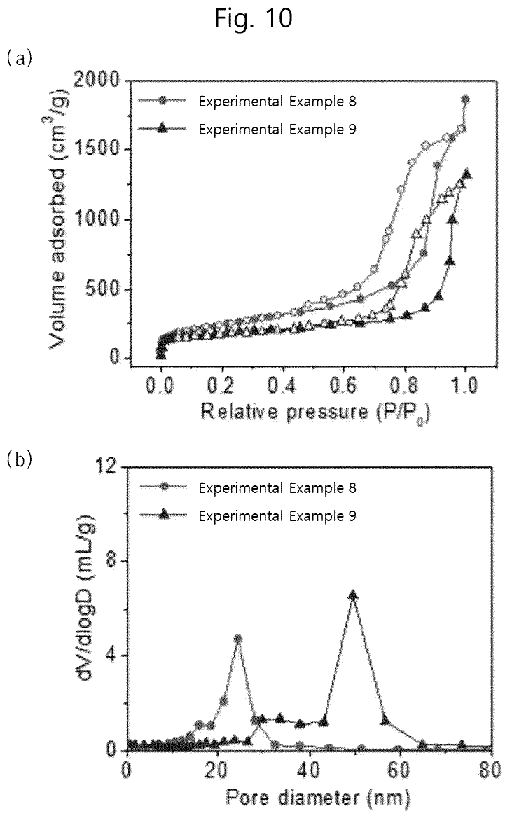

FIG. 10 is graphs showing the results of measuring specific surface areas and a pore distribution with regard to single-atom catalyst structures according to Experimental Examples 8 and 9. Specifically, FIG. 10 is a graph showing the results of measuring the specific surface area and pore volume using nitrogen isothermal adsorption. Referring to FIG. 10, it can be confirmed that single-atom catalyst structures according to Experimental Examples 8 and 9 have a decrease in a pore volume, which is 2 nm or less, and a mesopore volume of 25 nm and 50 nm, but maintain a main pore structure, in comparison with the activated three-dimensional ordered mesoporous carbon structures according to Experimental Examples 5 and 6.

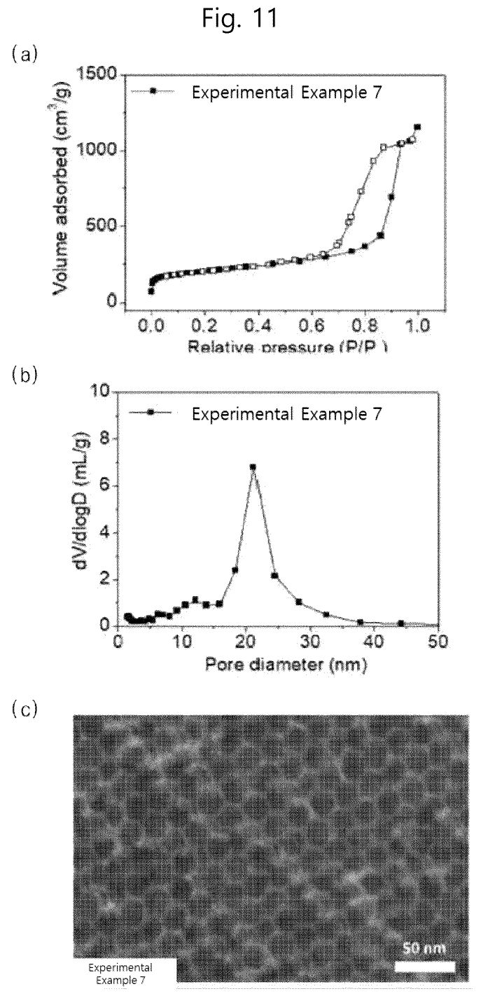

FIG. 11 is an SEM image, the results of measuring a specific surface area, and the results of analyzing a pore distribution with regard to Experimental Example 7. Specifically, FIG. 11 is a graph showing the results of measuring the specific surface area and pore volume using nitrogen isothermal adsorption. Referring to FIGS. 8 to 11, it can be confirmed that the single-atom catalyst structure according to Experimental Example 7 maintains a major pore structure, but a CO₂ activation process is not performed, and thus the specific surface area is greatly reduced, in comparison with the activated three-dimensional ordered mesoporous carbon structure according to Experimental Example 5.

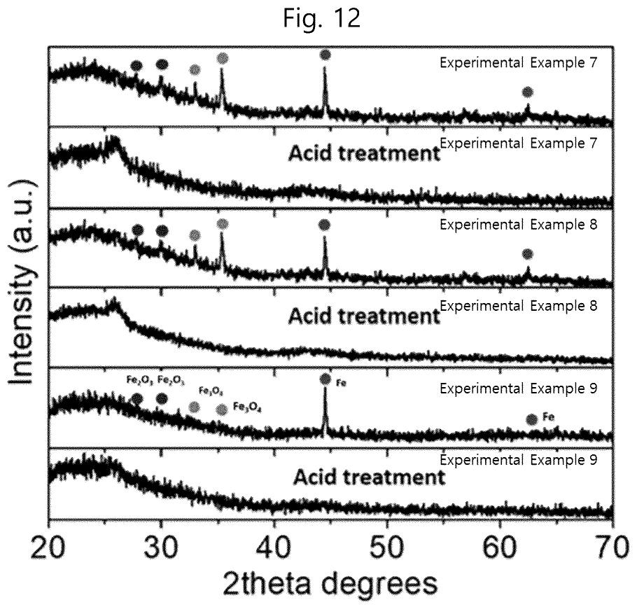

FIG. 12 is a graph showing the results of X-ray photoelectron spectroscopy (XRD) analysis of Experimental Examples 7 to 9.

Referring to FIG. 12, in the single-atom catalyst structures according to Experimental Examples 7 to 9, it can be confirmed that transition metal particles and transition metal oxide particles, such as Fe, Fe₂O₃, Fe₃O₄, etc., are identified before the composite mixture is provided in 0.5 M H₂SO₄, but the transition metal particles and the transition metal oxide particles are removed after the composite mixture is provided in 0.5 M H₂SO₄ and acid-treated. Accordingly, it can be confirmed that only Fe in a single-atom state is present in the single-atom catalyst structures according to Experimental Examples 7 to 9.

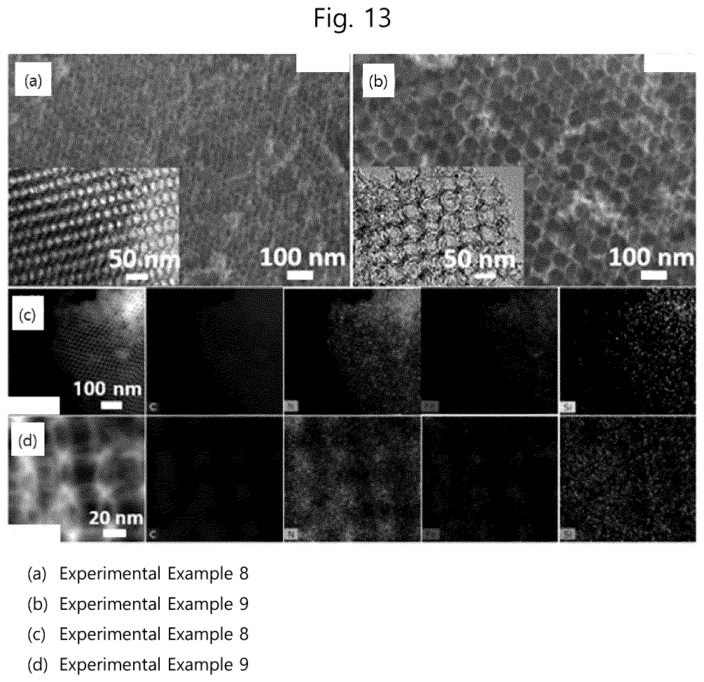

FIG. 13 is SEM and TEM images and graphs showing the results of EDS mapping with regard to Experimental Examples 8 and 9. Referring to FIG. 13, it can be confirmed that the monoatomic catalyst structures according to Experimental Examples 8 and 9 show a porous structure, and Fe, Si, N and C are uniformly distributed in the monoatomic catalyst structure.

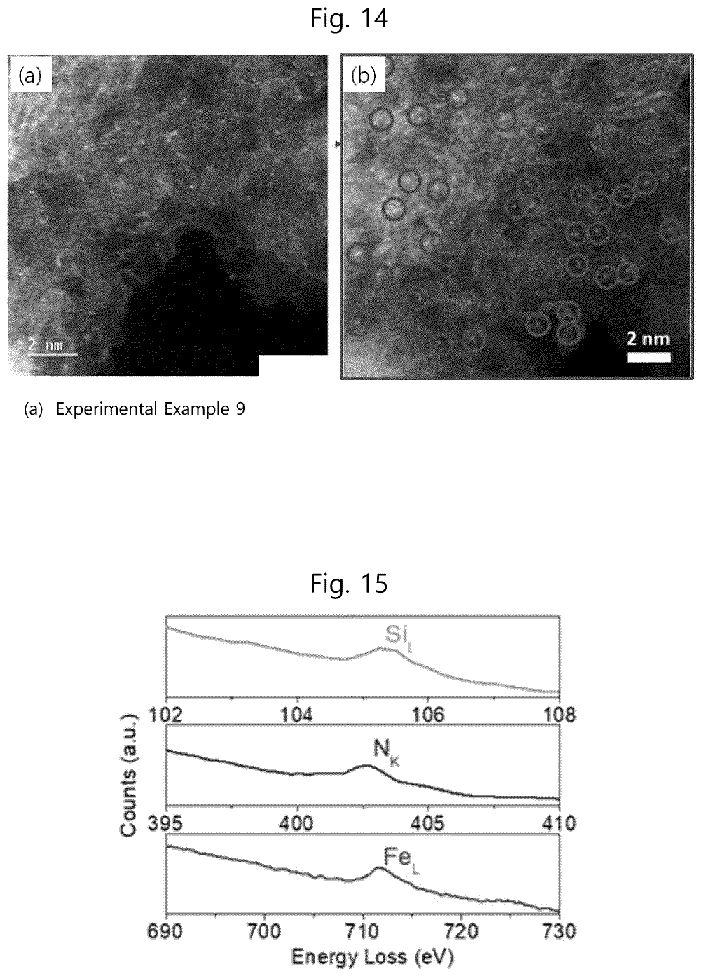

FIG. 14 is views showing a high-angle annular dark-field (HAADF) image of Experimental Example 9, and FIG. 15 is a graph showing the results of electron energy loss spectroscopy (EELS) analysis of Experimental Example 9. Specifically, FIG. 14 shows a mapping region of the HAADF image used to obtain the EELS results, and FIG. 15 shows the results of the EELS analysis using an image in (b) of FIG. 14, and the results of the XPS analysis are shown in Table 3.

Referring to FIGS. 14, 15, and Table 3, it can be confirmed that Fe, Si and N in a monoatomic state are bonded, and as a result of using XPS analysis, it can be confirmed that 0.21 wt % of silicon is included in the monoatomic catalyst structure (FeSiNC 25a) according to Experimental Example 8 and 0.19 wt % of silicon is included in the monoatomic catalyst structure (FeSiNC 50a) according to Experimental Example 9. In addition, it can be confirmed that 0.55 wt % of iron is included in the monoatomic catalyst structure according to Experimental Example 8 and 0.6 wt % of iron is included in the monoatomic catalyst structure according to Experimental Example 9. As a result of elemental analysis (EA), it can be confirmed that 1.98 wt % of nitrogen is included in the monoatomic catalyst structure according to Experimental Example 8 and 2.02 wt % of nitrogen is included in the monoatomic catalyst structure according to Experimental Example 9.

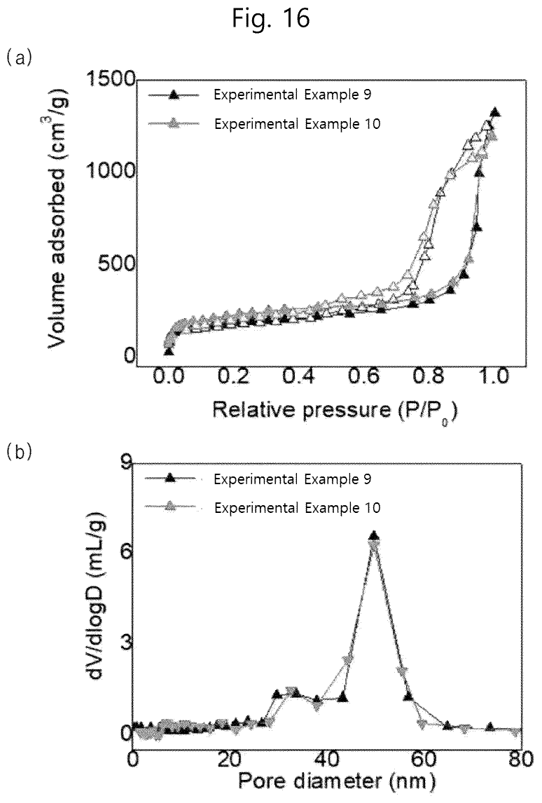

FIG. 16 is graphs showing the results of measuring specific surface areas and the results of analyzing a pore distribution with regard to single-atom catalyst structures according to Experimental Examples 9 and 10. Specifically, FIG. 16 is a graph showing the results of measuring the specific surface area and pore volume using nitrogen isothermal adsorption. Referring to FIG. 16 and Table 3, it can be confirmed that the single-atom catalyst structure according to Experimental Example 10 has a physical specific surface area and a pore volume similar to those of Experimental Example 9. However, it can be confirmed that a silicon content is greatly reduced compared to Experimental Example 9, since the structure uses 6M KOH at 100° C. as a first etching solution.

TABLE 4

| Classification | Experimental Example 8 | | | Experimental Example 9 | | |
|---|---|---|---|---|---|---|
| Path* | Fe—N | Fe—Si | Fe—C | Fe—N | Fe—Si | Fe—C |
| N | 4.1 ± 1.0 | 1.7 ± 0.8 | 2.5 ± 1.2 | 4.4 ± 1.7 | 3.3 ± 1.7 | 4.9 ± 2.8 |
| R(Å) | 1.960 ± 0.028 | 2.430 ± 0.014 | 3.036 ± 0.034 | 1.914 ± 0.040 | 2.408 ± 0.038 | 3.014 ± 0.058 |
| σ²(Å²) | 0.006 ± 0.003 | 0.006 ± 0.004 | 0.009 ± 0.008 | 0.008 ± 0.004 | 0.008 ± 0.005 | 0.011 ± 0.008 |

| | | |
|---|---|---|
| R-factor (%) | 0.1 | 0.8 |

Above Table 4 shows the fitting results of various metal bonds obtained using EXAFS analysis. Specifically, N represents a coordination number, R denotes a bond length, σ2 refers to a Deybe-waller factor (bond disorder), and R-factor means a fitting error rate (* denotes a fixed parameter).

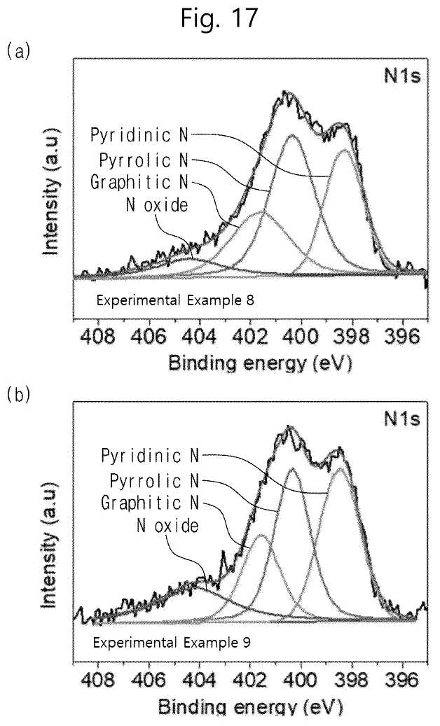

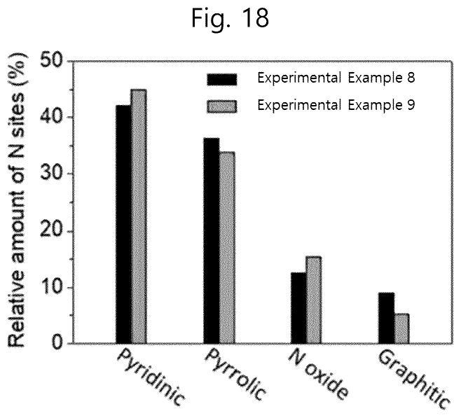

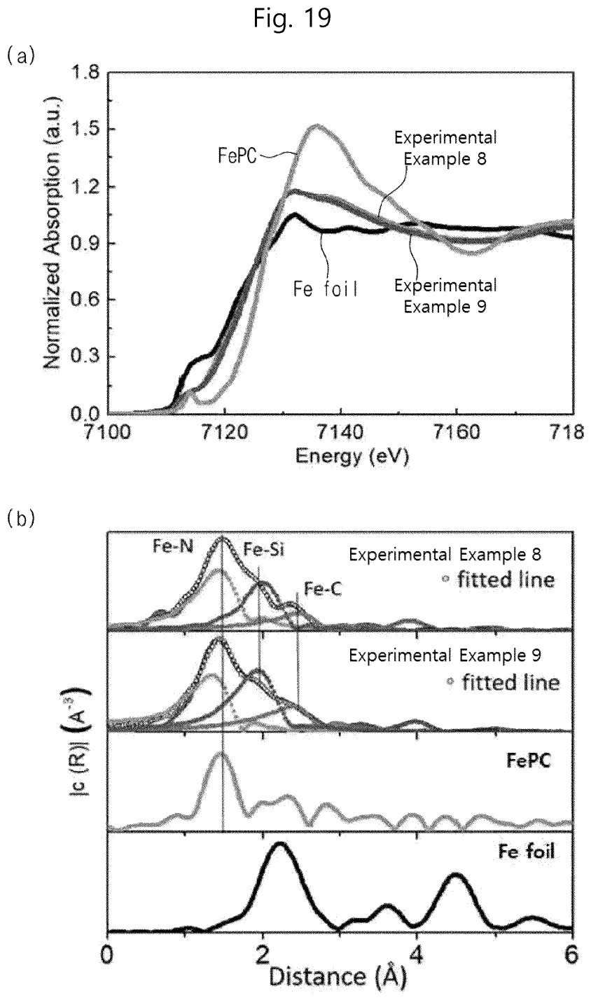

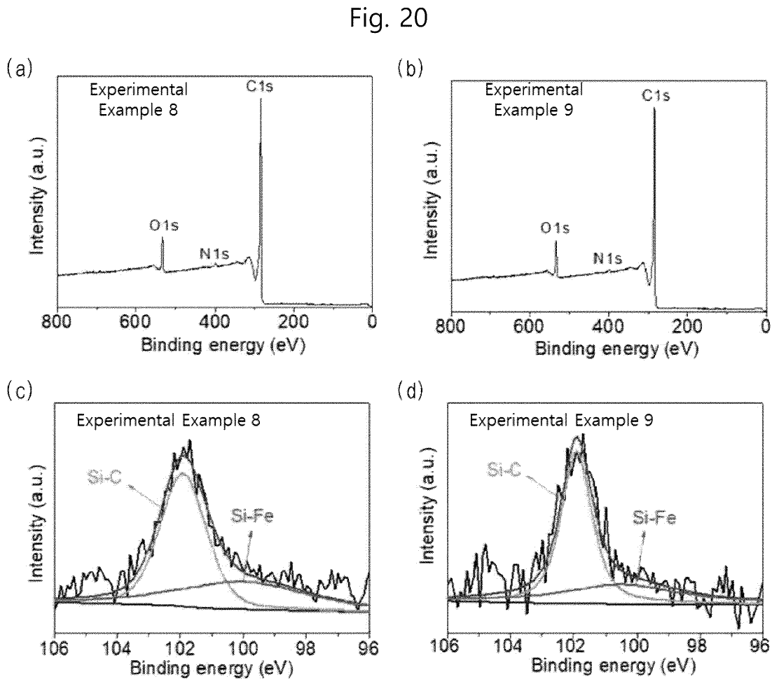

FIG. 17 is graphs showing the results of XPS analysis of single-atom catalyst structures according to Experimental Examples 8 and 9. Specifically, FIG. 17 is graphs showing the results of N Is XPS analysis. FIG. 18 is a graph showing an N functional group distribution of single-atom catalyst structures according to Experimental Examples 8 and 9. FIG. 19 is graphs showing the results of X-ray absorption near edge structure (XANES) and EXAFS of single-atom catalyst structures according to Experimental Examples 8 and 9. FIG. 20 is graphs showing the results of XPS scan and Si spectrum analysis of single-atom catalyst structures according to Experimental Examples 8 and 9. Specifically, (a) and (b) of FIG. 20 show the results of XPS scan and (c) and (d) of FIG. 20 shows the results of Si 2p spectrum analysis with regard to single-atom catalyst structures according to Experimental Examples 8 and 9.

Referring to FIGS. 17, 18 and Table 4, it can be confirmed that the monoatomic catalyst structures according to Experimental Example 8 and Experimental Example 9 all have pyridinic N, pyrrolic N, graphitic N, and N oxide functional groups, and in particular, pyridinic N and pyrrolic N functional groups are most included.

Referring to FIG. 19, as a result of XANES analysis in (a) of FIG. 19, it can be confirmed that the monoatomic catalyst structures according to Experimental Examples 8 and 9 have a structure in a rectangular Fe—Si—N3 form with a peak around 7114 eV, and it can be also confirmed that the monoatomic catalyst structures show a similar graph outline when compared to FePC (Iron(II) phthalocyanine).

Referring to (b) of FIG. 19, FIG. 20, Tables 3 and 4, as a result of extended X-ray absorption fine structure (EXAFS) fitting and XPS analysis, Fe—Si and Fe—C binding can be confirmed in addition to Fe—N binding. This can also be confirmed in the XPS of FIG. 10.

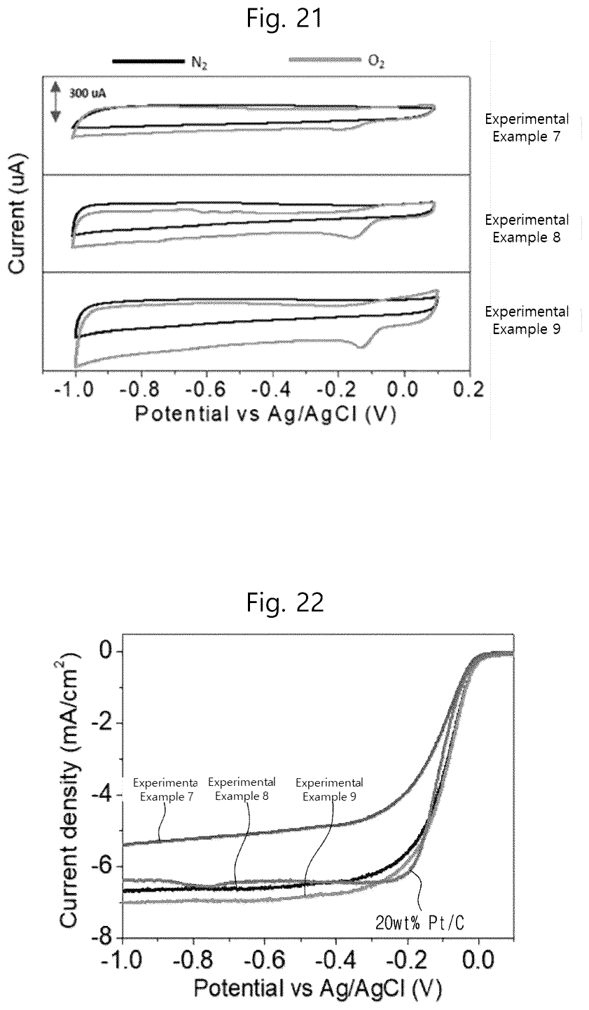

FIG. 21 is graphs showing the results of CV analysis under a nitrogen and oxygen atmosphere with regard to single-atom catalyst structures according to Experimental Examples 7 to 9.

Referring to Table 1 and FIG. 21, as a result of measuring CV in 0.1 M KOH electrolyte under a nitrogen or oxygen atmosphere, only the result of a double capacitor of carbon can be confirmed under a nitrogen atmosphere, but a peak related to oxygen reduction can be confirmed under an oxygen atmosphere with regard to all of the monoatomic catalyst structures according to Experimental Examples 7 to 9.

FIG. 22 is a graph showing the results of LSV of single-atom catalyst structures according to Experimental Examples 7 to 9. Specifically, it shows the LSV result at 1600 rpm in 0.1 M KOH electrolyte.

Referring to Table 3 and FIG. 22, as a result of LSV evaluation, it could be confirmed that the single-atom catalyst structure according to Experimental Example 9 exhibits the most excellent performance at 0.056 mA/cm², and in the case of a commercial Pt/C catalyst, it can be confirmed that the single-atom catalyst structure according to Experimental Example 9 exhibits the most excellent performance at 0.046 mA/cm² compared to the commercial catalyst.

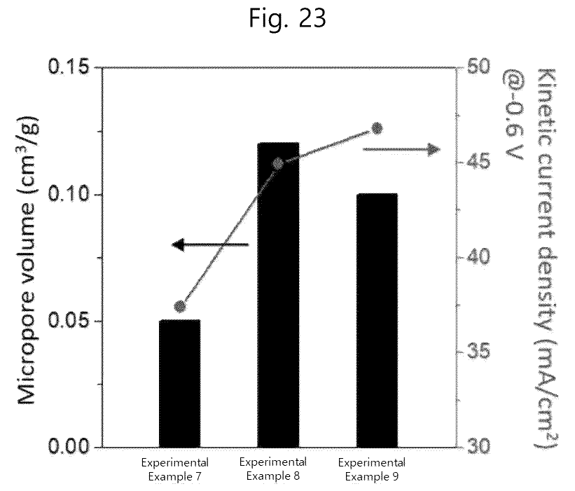

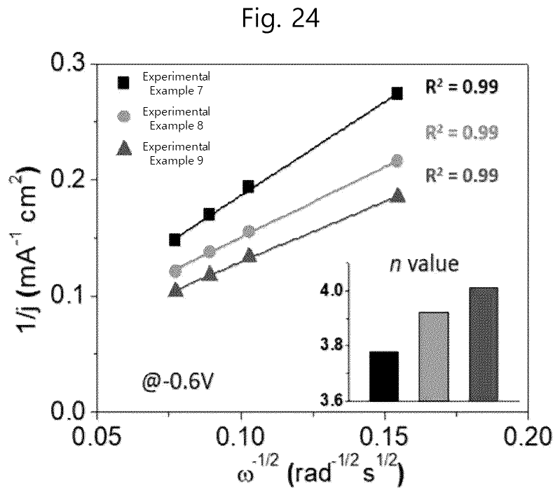

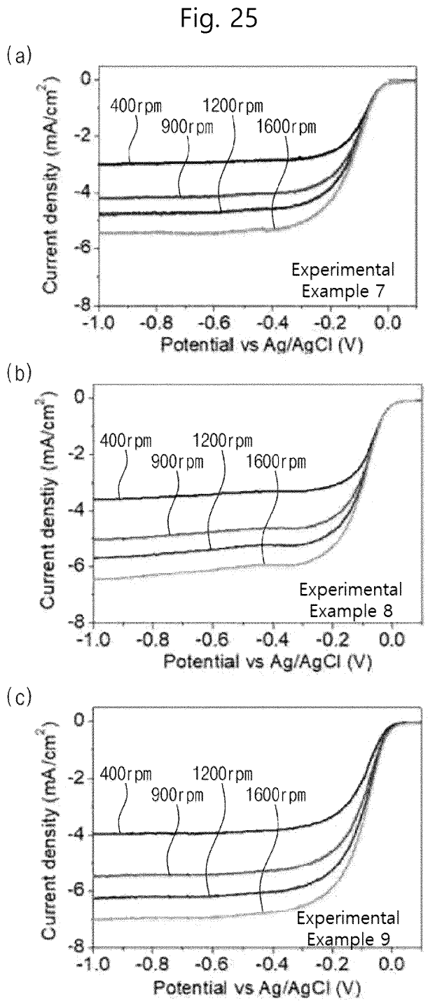

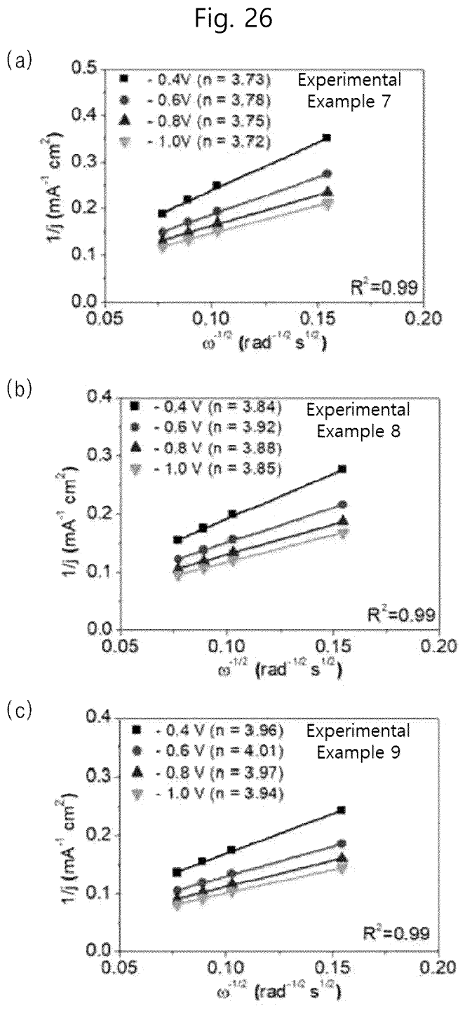

FIG. 23 is a graph showing the results of pore volume and kinetic current density analysis with regard to single-atom catalyst structures according to Experimental Examples 7 to 9. FIG. 24 is a graph showing an electron transfer number of single-atom catalyst structures according to Experimental Examples 7 to 9. Specifically, FIG. 24 shows an electron transfer number calculated with K-L plot. FIG. 25 is graphs showing the results of LSV of single-atom catalyst structures according to Experimental Examples 7 to 9. Specifically, FIG. 25 shows the LSV results under the conditions of 400 rpm to 1600 rpm. FIG. 26 is a graph showing an electron transfer number of single-atom catalyst structures according to Experimental Examples 7 to 9. Specifically, FIG. 26 shows an electron transfer number calculated with K-Lplot under the condition of 400 rpm to 1600 rpm.

Referring to FIGS. 23 to 26 and Table 3, it can be confirmed that the on-set voltage, which is a voltage required for the single-atom catalyst structure according to Experimental Example 9 to reach a current of 0.1 mA/cm², has the most excellent performance.

This is because large pores are formed to have excellent mass transfer diffusion capacity as well as excellent oxygen reduction activity with an increase in the formation of catalyst active points due to the development of micropores.

In addition, it can be confirmed that the single-atom catalyst structure according to Experimental Example 9 has also the most excellent kinetic current density with the same tendency as that of the excellent oxygen reduction reaction, and it can be confirmed that an electron transfer number is 4.01, which is perfectly 4 electronic reaction.

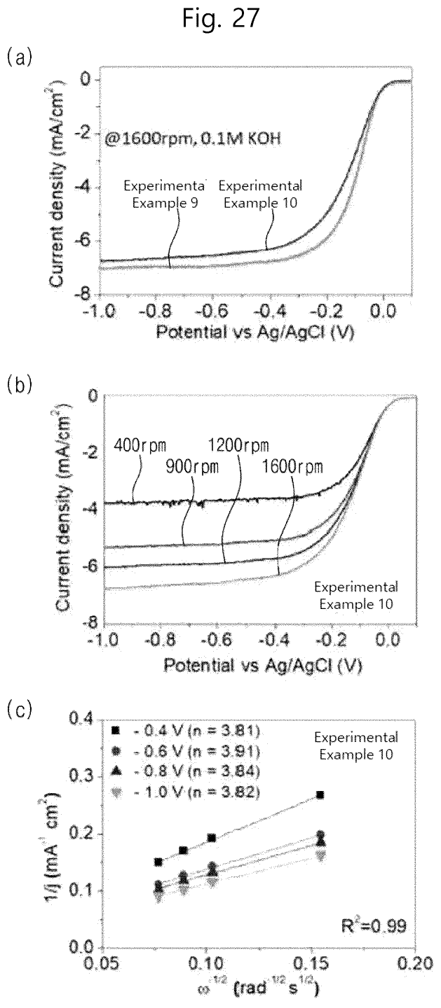

FIG. 27 is graphs showing the results of LSV and the results of an electron transfer number with regard to a single-atom catalyst structure according to Experimental Example 10. Specifically, (a) of FIG. 27 shows the LSV results of the single-atom catalyst structure according to Experimental Example 10, (b) of FIG. 27 shows the LSV results at an RPM of the single-atom catalyst structure according to Experimental Example 10, and (c) of FIG. 27 shows an electron transfer number with the K-Lplot of the single-atom catalyst structure according to Experimental Example 10.

Referring to FIGS. 22 to 27 and Table 3, the effect of silicon doping on oxygen activity can be confirmed. As a result of LSV and electron transfer number analysis of the monoatomic catalyst structure according to Experimental Example 10, it can be confirmed that the oxygen reduction reaction is lower compared to the single-atom catalyst structure according to Experimental Example 9. It can be confirmed that the bimetallic doping of Fe—Si has a relatively greater effect on the oxygen reduction reaction activity compared with monometallic doping.

TABLE 5

| | On-set Potential | Half-wave |
|---|---|---|
| Catalyst sample | (ν vs RHE) | (V vs RHE) |
| Fe—N—CNF | 0.93 | 0.81 |
| Fe—NMCs | 1.027 | 0.86 |
| Fe@C—FeNC-2 | — | 0.899 |
| Fe—N/C-800 | 0.923 | 0.809 |
| PMF-800 | — | 0.861 |
| N—CSN-120 | 0.888 | 0.754 |
| Fe—N—CC | 0.94 | 0.83 |
| Fe3C/C-800 | 1.05 | 0.83 |
| CoP NCs | 0.8 | 0.7 |
| NPOMC-L1 | 0.92 | 0.82 |
| Co304/N-rmGo | 0.9 | 0.83 |
| Cop-CMP8oo | 0.844 | 0.774 |
| NL-C | 0.95 | 0.85 |
| Experimental Example 9* | 1.02* | 0.858* |

Above Table 5 shows a comparison of the oxygen reduction reaction performance between various commercial catalysts, and it can be confirmed that the single-atom catalyst structure according to Experimental Example 9 of the present invention has excellent oxygen reduction reaction. In this case, * was expressed by conversion using the equation RHE (V)=Ag/AgCl (V)+0.964 V.

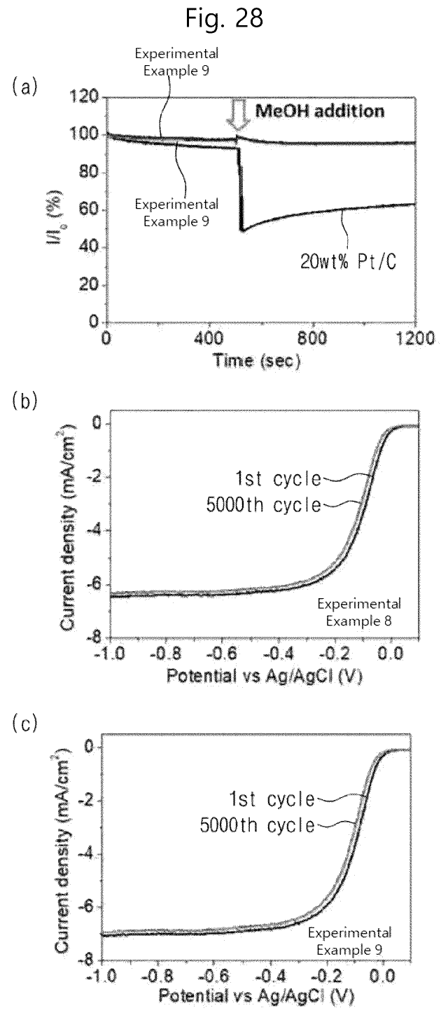

FIG. 28 is graphs showing the results of a methanol poisoning experiment and the results of evaluating long-term durability with regard to single-atom catalyst structures according to Experimental Examples 8 and 9. Specifically, (a) of FIG. 28 shows the results of measuring the durability evaluation using 1 M methanol (MeOH) in order to confirm the applicability of the direct methanol fuel cell (DMFC) of the single-atom catalyst structures according to Experimental Examples 8 and 9, and (b) and (c) of FIG. 28 show the results of long-term durability evaluation with regard to the monoatomic catalyst structures according to Experimental Examples 8 and 9 using the ADT method, respectively.

Referring to FIG. 28, in the case of a commercial catalyst (20% Pt/C), it can be confirmed that the activity of the catalyst is reduced due to a methanol poisoning phenomenon when exposed to methanol, but the monoatomic catalyst structures according to Experimental Examples 8 and 9 are not affected by methanol. In addition, it can be confirmed that long-term durability is excellent through stable maintenance until 5000 cycles.

TABLE 6

| Classification | Maximum Power Density (mW/cm2) |
|---|---|
| C-MOF-C2-900 | 105 |
| Fe—N—C | 100 |
| NDGs-800 | 115 |
| NiCo204@Mn02-CNTs-3 | 86 |
| CN-800 | 80 |
| FeBNC-800 | 9 |
| N—HCN | 76 |
| CF—K—A | 62 |
| CNTs@Co—N—C | 148 |
| Co—NCNT/Ng-900 | 174 |
| SN—PC-a | 11 |
| N, P—Ne-1000 | 146 |
| Experimental Example 9 | 127 |

Above Table 6 shows the results of evaluating performance using various catalysts as an electrode of a Zn-Air battery (ZAB).

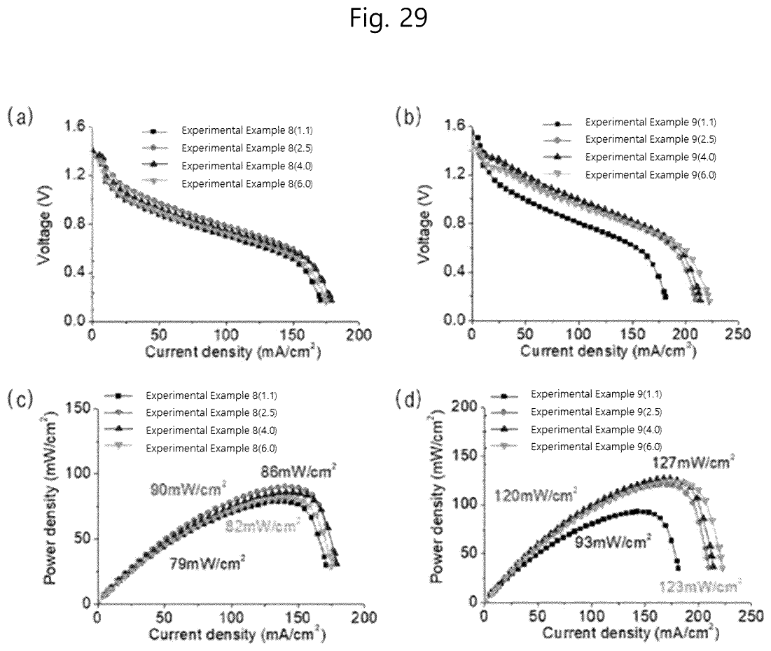

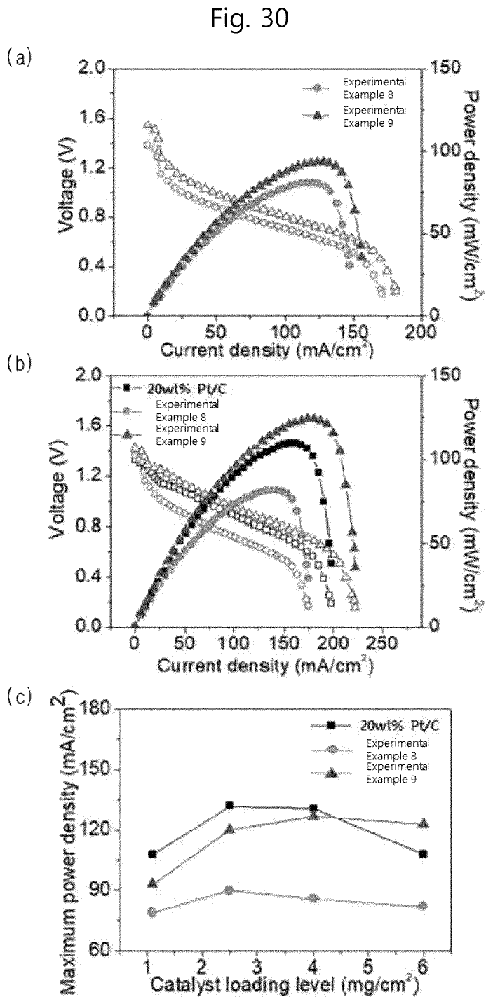

FIG. 29 is graphs showing the results of analyzing ZAB performance according to a weight of single-atom catalyst structures according to Experimental Examples 8 to 9. FIG. 30 is graphs showing the results of analyzing ZAB performance according to an amount of catalyst used in single-atom catalyst structures according to Experimental Examples 8 to 9. Specifically, FIG. 30 shows the results of performance evaluation by utilizing the monoatomic catalyst structures according to Experimental Examples 8 and 9 as a cathode of ZAB, and thus a change in performance according to a catalyst weight and amount can be confirmed.

Referring to FIGS. 29, 30, and Table 6, in the case of the catalyst used in the related art and the 20 wt % Pt/C catalyst, it can be confirmed that the oxygen reduction reaction activity is high when a loading amount of the catalyst is as small as 1.1 mg/cm², but a catalyst layer is thickly formed to cause a clogging phenomenon, and thus the oxygen reduction reaction activity is not efficiently exhibited when a loading amount is increased more than 1.1 mg/cm². On the contrary, since the single-atom catalyst structures according to Experimental Examples 8 and 9 have a large number of wide pores, it can be confirmed that the diffusion of electrolyte, reactant, etc., is increased and stable and excellent oxygen reduction reaction activity is exhibited even when a loading amount of the catalyst is increased.

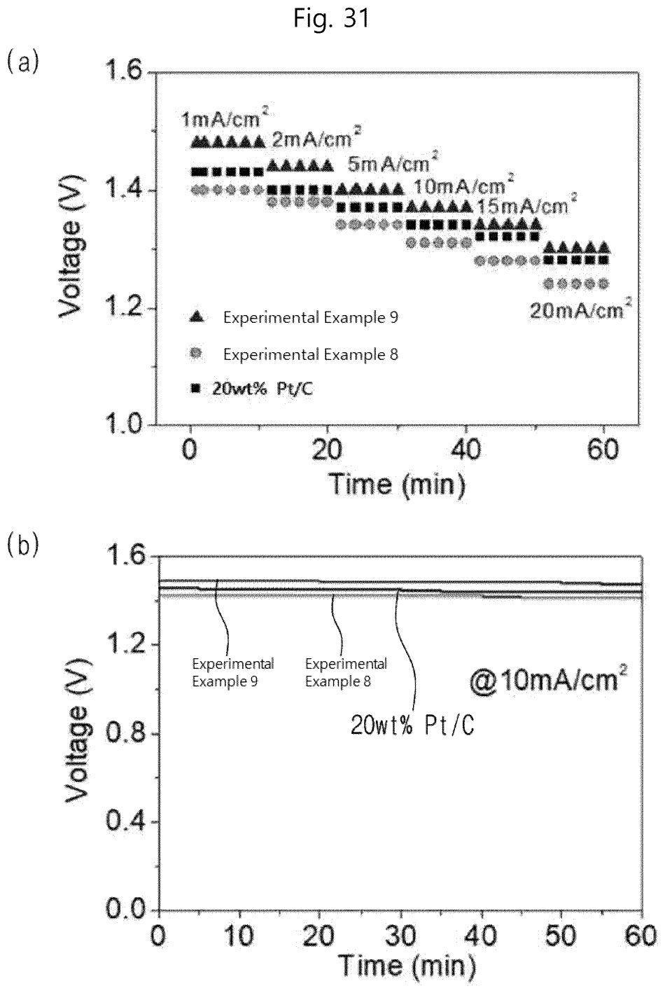

FIG. 31 is graphs showing the results of analyzing ZAB performance according to a rate of single-atom catalyst structures according to Experimental Examples 8 and 9. Specifically, (a) of FIG. 31 shows the results of analyzing ZAB performance according to a rate of single-atom catalyst structures according to Experimental Examples 8 and 9, and (b) of FIG. 31 shows the results of performance evaluation for 60 minutes.

Referring to FIG. 31, it can be confirmed that both the performance change according to the rate and the performance evaluation for 60 minutes are stable.

In addition, referring to FIGS. 29 to 31, as a result of comparing the results of evaluating properties using a fuel-cell system such as ZAB, it can be confirmed that a difference in diffusion capacity changes depending on a pore size is reflected very much compared to a half-cell (RDE).

Although the present invention has been described in detail with reference to exemplary embodiments, the scope of the present invention is not limited to a specific embodiment and should be interpreted by the attached claims. In addition, those skilled in the art should understand that many modifications and variations are possible without departing from the scope of the present invention.

The single-atom catalyst structure according to an embodiment of the present application and the method for preparing the same can be utilized in various industrial fields such as a cathode catalyst of an anion exchange membrane fuel cell, a cathode catalyst of a metal-air battery, and the like.

1. A method for preparing a single-atom catalyst structure, the method comprising:
preparing a three-dimensional ordered mesoporous carbon structure;
activating the three-dimensional ordered mesoporous carbon structure; and
preparing a single-atom catalyst structure by doping a single-atom catalyst, including transition metal, nitrogen, and carbon, in the activated three-dimensional carbon structure.

2. The method of claim 1, wherein the preparing of the three-dimensional ordered mesoporous carbon structure comprises:
preparing a carbon source;
providing the carbon source to a porous silicon oxide structure to prepare a silicon oxide-carbon pre-structure;
heat-treating the silicon oxide-carbon pre-structure under an inert gas atmosphere to prepare a silicon oxide-carbon structure; and
providing the silicon oxide-carbon composite in a first etching solution to prepare the three-dimensional ordered mesoporous carbon structure from which silicon oxide is removed.

3. The method of claim 2, wherein the preparing of the three-dimensional ordered mesoporous carbon structure comprises:
controlling a temperature of the first etching solution to control presence and absence of silicon in the three-dimensional ordered mesoporous carbon structure and presence and absence of silicon included in the single-atom catalyst structure.

4. The method of claim 2, wherein in the preparing of the three-dimensional ordered mesoporous carbon structure,
a part of the silicon not removed by the first etching solution remains in the three-dimensional ordered mesoporous carbon structure, so that silicon is further included in the single-atom catalyst.

5. The method of claim 1, wherein the preparing of the single-atom catalyst structure further comprises:
providing a transition metal source and a nitrogen source to the activated three-dimensional ordered mesoporous carbon structure to prepare a transition metal-nitrogen-three-dimensional ordered mesoporous carbon structure mixture;
heat-treating the transition metal-nitrogen-three-dimensional ordered mesoporous carbon structure mixture to prepare a composite mixture including transition metal particles, transition metal oxide particles, and a single-atom catalyst; and
providing the composite mixture into a second etching solution to remove the transition metal particles and the transition metal oxide particles, and leaving the single-atom catalyst.

6. The method of claim 5, wherein the second etching solution comprises an acidic solution.

7. A single-atom catalyst structure comprising:
a three-dimensional ordered mesoporous carbon structure; and
a single-atom catalyst doped inside the three-dimensional ordered mesoporous carbon structure, wherein
the single-atom catalyst includes transition metal, nitrogen, and carbon.

8. The single-atom catalyst structure of claim 7, wherein the single-atom catalyst is configured in which each of the three or more nitrogen elements is bonded to the transition metal element, and
the nitrogen element bonded to the transition metal element forms a heterocycle with a plurality of carbons of the three-dimensional ordered mesoporous carbon structure.

9. The single-atom catalyst structure of claim 7, wherein the single-atom catalyst further comprises silicon,
in which each of the three or more nitrogen elements and the one or more silicon elements is bonded to the transition metal element, and
the nitrogen element and the silicon element bonded to the transition metal element form a heterocycle with a plurality of carbons of the three-dimensional ordered mesoporous carbon structure.

10. The single-atom catalyst structure of claim 7, wherein the single-atom catalyst structure has
no peak corresponding to transition metal particles and transition metal oxide particles shown in XRD analysis.

11. A cathode electrode comprising the single-atom catalyst structure according to claim 7.

12. A cathode electrode comprising the single-atom catalyst structure according to claim 8.

13. A cathode electrode comprising the single-atom catalyst structure according to claim 9.

14. A cathode electrode comprising the single-atom catalyst structure according to claim 10.

15. A fuel cell comprising the single-atom catalyst structure according to claim 7.

16. A fuel cell comprising the single-atom catalyst structure according to claim 8.

17. A fuel cell comprising the single-atom catalyst structure according to claim 9.

18. A fuel cell comprising the single-atom catalyst structure according to claim 10.
